(19) United States
(12) Patent Application Publication
(10) Pub. No.: US 2025/0190523 A1
(43) Pub. Date: Jun. 12, 2025

(54) LUT-FREE HARDWARE BASED SOFTMAX ACCELERATOR

(71) Applicant: Intel Corporation, Santa Clara, CA (US)

(72) Inventors: Kamlesh Pillai, Bangalore (IN); Bogdan Pasca, Toulouse (FR); Martin Langhammer, Alderbury (GB)

(73) Assignee: Intel Corporation, Santa Clara, CA (US)

(21) Appl. No.: 19/055,819

(22) Filed: Feb. 18, 2025

(51) Int. Cl. G06F 17/16; G06F 7/544; G06F 9/448

(52) U.S. Cl. CPC G06F 17/16; G06F 7/5443; G06F 9/4498

(57) ABSTRACT

SoftMax operation is one part of a deep neural network (DNN). Because computing SoftMax is complex and time-consuming, the SoftMax operation can limit the overall execution latency of the DNN. To address this issue, an in-line data path is added to pass output data from a matrix-to-matrix multiplication core to a hardware SoftMax accelerator. During a denominator phase of the SoftMax operation, the SoftMax accelerator can operate in-line to produce a denominator value using output values generated by the matrix-to-matrix multiplication core and received over the in-line data path. During a numerator phase of the SoftMax operation, the SoftMax accelerator can calculate SoftMax outputs using output values generated by the matrix-to-matrix multiplication core and retrieved from a memory. In other words, the SoftMax accelerator can produce partial results while the matrix-to-matrix multiplication is in-flight to cut down overall latency and reduce memory transactions.

### BACKGROUND

Deep neural networks (DNNs) are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as there can be a large number of operations as well as a large amount of data to read and write.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a block in a transformer-based neural network, according to some embodiments of the disclosure.

FIG. 2 illustrates operations in an attention layer, according to some embodiments of the disclosure.

FIG. 3 illustrates hardware acceleration involving a look-up table implementation for the SoftMax operation, according to some embodiments of the disclosure.

FIG. 4 illustrates hardware acceleration involving partial in-line execution of SoftMax, according to some embodiments of the disclosure.

FIG. 5 illustrates states of a finite state machine, according to some embodiments of the disclosure.

FIG. 6 illustrates timing of performing matrix-to-matrix multiplication operations and performing a part of SoftMax in-line with the matrix-to-matrix multiplication operations, according to some embodiments of the disclosure.

FIG. 7A illustrates an algorithm for handling scaling, according to some embodiments of the disclosure.

FIG. 7B illustrates hardware logic for handling scaling, according to some embodiments of the disclosure.

FIG. 8 illustrates hardware components in an exemplary SoftMax accelerator, according to some embodiments of the disclosure.

FIG. 9 illustrates hardware components in a further exemplary SoftMax accelerator, according to some embodiments of the disclosure.

FIG. 10 illustrates hardware components in a yet further exemplary SoftMax accelerator, according to some embodiments of the disclosure.

FIG. 11 illustrates hardware components in an exemplary SoftMax accelerator implementing modified SoftMax, according to some embodiments of the disclosure.

FIG. 12 is a flowchart showing a method for performing at least a part of SoftMax in-line with a matrix-to-matrix multiplication core, according to some embodiments of the disclosure.

FIG. 13 is a flowchart showing a method for causing a SoftMax accelerator to perform at least a part of SoftMax in-line with a matrix-to-matrix multiplication core, according to some embodiments of the disclosure.

FIG. 14 is a block diagram of an exemplary computing device, according to some embodiments of the disclosure.

### DETAILED DESCRIPTION

### Overview

The last decade has witnessed a rapid rise in artificial intelligence (AI) based data processing, particularly based on DNNs. DNNs are widely used in the domains of computer vision, speech recognition, image, and video processing mainly due to their ability to achieve beyond human-level accuracy. A DNN typically includes a sequence of layers. A DNN layer may include one or more deep learning operations (also referred to as “neural network operations”), such as convolution operation, matrix multiplication operation, layer normalization operation, batch normalization operation, SoftMax operation, pooling operation, elementwise operation, linear operation, nonlinear operation, and so on. While DNNs are effective at analyzing and predicting, they come at a cost of immense computational power. DNNs can consume significant power and runtime during training and during inference.

Transformer-based neural networks or transformer-based models are a type of DNN that can be used to power large language models (LLMs) and computer vision models (referred to in literature as ViTs). Transformer-based neural networks are used in services and applications such as natural language processing, speech processing, conversational AI assistants, image captioning, object detection, video understanding, recommendation systems, bioinformatics, time-series forecasting, reinforcement learning, and generative models to produce text, image, or music. Unlike other types of DNNs, such as convolutional neural networks (CNNs), where the SoftMax operation is only used in the output layer, transformer-based neural networks include the SoftMax operation in every layer. The SoftMax operation can be a bottleneck when executing a transformer-based neural network on a processor, especially when sequence lengths become longer, and models become larger. Within the computation pipeline of a transformer-based neural network, the SoftMax operation can consume a significant amount of runtime (second to matrix multiplication or MatMul). In some pipelines, the SoftMax operation can consume 20%-40% of the overall runtime on a processor. The ability to improve the efficiency of the SoftMax operation carried out on a processor can significantly improve the overall runtime of the transformer-based neural network or other neural networks that utilizes SoftMax.

Input or output data of deep learning operations may be arranged in data structures called tensors. In the case of a SoftMax operation, the SoftMax operation may operate on an input tensor and output an output tensor. In the case of a matrix multiplication (MatMul) operation or matrix-to-matrix multiplication operation, the MatMul operation may operate on a first input tensor and a second input tensor and output an output tensor that represents the product of the first input tensor and the second input tensor multiplied together.

A tensor is a data structure having multiple elements across one or more dimensions. Examples of tensors include a vector (which is one-dimensional (1D) tensor), a matrix (which is two-dimensional (2D) tensor), a three-dimensional (3D) tensor, a four-dimensional (4D) tensor, and even higher dimensional tensors. A dimension of a tensor may correspond to an axis, e.g., an axis in a coordinate system. A dimension may be measured by the number of data points along the axis. The dimensions of a tensor may define the shape of the tensor. A DNN layer may receive one or more input tensors and compute an output tensor from the one or more input tensors. Tensors in DNNs can be saved in X-major (e.g., XYZ or XZY format), Y-major formats (e.g., YXZ or YZX format), or Z-major formats (e.g., ZXY or ZYX format). The format of a tensor may define the order in which the data points in the tensor are stored, written, or read. The first character may represent the dimension in which data points are contiguous in memory. The second character may represent the dimension in which data points can be accessed after the contiguous data points are accessed in memory. The third character may represent the dimension in which data points are accessed after the data points in the dimension represented by the second character are exhausted. Taking the ZXY format for example, the access order first starts in the Z dimension, then moves to the X dimension, and finally moves to the Y dimension. Data points in the tensor are contiguous in memory in the Z dimension, meaning data points having the same (x, y) coordinates are contiguous in memory. Using tensor permutation, the tensor may be read from memory in a different format.

The SoftMax operation can take an input tensor having K elements zᵢ (along a specified dimension) and applies the SoftMax operation on the elements xᵢ to produce an output tensor having elements yᵢ. The SoftMax operation can convert the elements xᵢ into probabilities yᵢ of a probability distribution, where the values or probabilities are non-negative and sum to 1. The values may be within a range from 0 to 1. The mathematical representation of the SoftMax operation is as follows:

$${σ ( \vec{z} )}_{i} = \frac{{e}^{{z}_{i} - max ( {z}_{i} )}}{{\sum }_{j = 1}^{K} {e}^{{z}_{j} - max ( {z}_{j} )}} \qquad ( eq . 1 )$$

Where max(xᵢ) denotes the maximum value of the elements xᵢ. Subtracting by max(zᵢ) can ensure numerical stability and may be optional. K is the size of the input vector \vec{z} (e.g., number of values in input vector \vec{z}). A simpler mathematical representation of the SoftMax operation is as follows:

$${σ ( \vec{z} )}_{i} = \frac{{e}^{{z}_{i}}}{{\sum }_{j = 1}^{K} {e}^{{z}_{j}}} \qquad ( eq . 2 )$$

As illustrated in equation 1 and equation 2, the SoftMax operation calculates relative probabilities. Calculating SoftMax involves extensive computations and suffers from high latency. Also, calculating SoftMax can utilize a large amount of memory transactions, which in turn slows down the overall neural network execution further and increases power consumption. In particular, calculating SoftMax involves computing the exponential of a vector of variables, accumulating the exponentials across output channel for an output feature map (OFM), and dividing the exponential by the accumulated exponentials, etc.

Some DNN accelerators support SoftMax by using a look-up table (LUT) and dedicated hardware to utilize the LUT values. The LUT approach is used due to its reliability and accuracy across the entire spectrum of the SoftMax curve. One way to generate the LUT entries is to split the input interval of the activation function into several subintervals and the activation function is piecewise approximated by a polynomial on each of the subintervals. The LUT can have LUT entries having the polynomial coefficients of varying polynomial degrees for each subinterval. Based on the input sample and the subinterval in which the input sample falls in, the corresponding set of polynomial coefficients can be fetched from the LUT. Dedicated hardware can approximate the SoftMax output by performing the mathematical operations of the polynomial using the fetched polynomial coefficients. Unfortunately, LUT-based solutions for SoftMax can incur high workload overhead and incur high performance/area/power. Higher accuracy requires larger LUTs and thus incurring high area penalty. The size of the LUT can grow exponentially with increasing accuracy requirements. If the LUT is not placed close to the compute units, the overall performance may be affected by the high latency. Sharing the LUT across multiple compute channels can require a multi-ported LUT, and the cost and complexity of arbitration and muxing can increase with addition of each port, to the point where the arbitration logic can exceed the actual memory cost. For these reasons realizing SoftMax using LUT hardware adds significant power/performance/area costs.

Some DNN accelerators support SoftMax by approximating the SoftMax equation using dedicated hardware and solving for each variable in the DNN. Approximating the SoftMax operation can suffer from accuracy loss and implementation complexity. Scaling the dedicated hardware solution grow in area linearly, or worse, exponentially, with targeted Unit of Least Precision requirements. A naïve implementation of the SoftMax equation can result in twice the memory transactions. First, 1× number of OFM entries memory reads are used to calculate the denominator of the SoftMax equation (e.g., as seen in equation 1 and equation 2). The denominator is available only after reading all the OFM entries. After that, another 2× number of OFM entries are used to perform the division operation (e.g., as seen in equation 1 and equation 2) to obtain the SoftMax outputs. In some DNN accelerators, one or more mathematical operations within the SoftMax equation, such as the calculating the exponential and calculating the reciprocal, are realized using LUTs. These implementations can suffer from even higher latency because the LUTs can be a part of the extended math unit. The extended math unit can serve as a common resource across multiple execution units and can have very high execution latency.

Because computing SoftMax is complex and time-consuming, the SoftMax operation can limit the overall execution latency of the DNN. To address this issue, an in-line data path is added to pass output data from a matrix-to-matrix multiplication core to a hardware SoftMax accelerator. The in-line data path can be used to send output data to the SoftMax accelerator for processing and bypass the memory. The in-line data path may include one or more wires that directly connect the matrix-to-matrix multiplication core to the SoftMax accelerator. In some cases, the one or more wires may tap one or more memory write lines of the matrix-to-matrix multiplication core to pass the output data being written to the memory onto the SoftMax accelerator (before the output data reaches the memory). In addition, the SoftMax accelerator can be realized in hardware without using LUTs.

Herein, a matrix-to-matrix multiplication core can perform operations such as matrix multiplication and convolution. A matrix-to-matrix multiplication core may be referred to herein as General Matrix-to-Matrix Multiplication (GEMM) core. GEMM core may include a systolic array architecture for parallel computation, where multiple processing elements can be arranged in a grid to efficiently perform multiplication and accumulation. The processing elements may have local memory and accumulation registers, and the data flow within a GEMM core can be optimized for matrix multiplication and convolution operations. A GEMM core can perform dot product computations to support matrix multiplication and convolution sliding window calculations.

The denominator computation and the numerator computation of the SoftMax operation, as illustrated in equation 1 and equation 2, are decoupled into separate phases: a denominator phase and a numerator phase respectively. The SoftMax accelerator can be operated in different phases.

During a denominator phase of the SoftMax operation, the SoftMax accelerator can operate in-line to produce a denominator value using output values generated by the matrix-to-matrix multiplication core and received over the in-line data path. The denominator phase can calculate the following:

$$\frac{1}{{\sum }_{j = 1}^{K} {e}^{{z}_{j}}} \qquad ( eq . 3 )$$

During a numerator phase of the SoftMax operation, the SoftMax accelerator can calculate SoftMax outputs using output values generated by the matrix-to-matrix multiplication core and retrieved from a memory. The numerator phase can calculate the final SoftMax outputs according to equation 1 or equation 2.

In other words, the SoftMax accelerator can produce partial results in the denominator phase while the matrix-to-matrix multiplication is in-flight to cut down overall latency and reduce memory transactions. In one comparison against some DNN accelerators, the overall latency and memory transactions are cut by roughly 50%. Moreover, the SoftMax accelerator can be implemented without LUTs, and avoid having to pay the high performance/area/power tax.

The micro-architecture of the SoftMax accelerator can include a memory controller and a compute block. The compute block can include one or more adders, one or more multipliers, and one or more reciprocals. The memory controller can decode an incoming instruction and configure the SoftMax accelerator to operate according to the different phases.

The memory controller can read incoming output data computed by the matrix-to-matrix multiplication core via the in-line data path during the denominator phase. The compute block can perform the reduction operation using an exponential and an adder to calculate the sum, e.g., Σⱼ₌₁^{K}e^{z}^{ⱼ} of equation 3, during the denominator phase. At the same time, the matrix-to-matrix multiplication core generates and stores the output data as OFMs in the memory. At the end of denominator phase, the compute block uses a reciprocal (e.g., used only once in the SoftMax operation) to compute the reciprocal of the denominator, e.g., equation 3, and store this result in a local register of the compute block.

The memory controller can perform read operations from memory during the numerator phase. During the numerator phase, the memory controller reads the output data from the memory, which was written to the memory by the matrix-to-matrix multiplication core. The compute block uses an exponential and a multiplier to complete the SoftMax operation for a given input, e.g., zᵢ, from the input vector, e.g., \vec{z}. The SoftMax outputs from numerator phase (which can serve as an input feature map (IFM) for next neural network layer) are written to the memory by the memory controller.

The synchronization between switching of denominator phase and numerator phase are efficiently handled by the memory controller and one or more finite state machines (FSMs) programmed according to the received instruction. A finite state machine can keep track of the number of values accumulated and a number of SoftMax outputs calculated, and transition states accordingly. A processing path involving the adder can be enabled during the denominator phase to accumulate exponentials. The reciprocal is activated once at the end of the denominator phase. The processing path involving the adder can be disabled and the compute block switches to utilize the processing path involving the multiplier during the numerator phase. FSM based synchronization toggles between the two phases of operations internally in the SoftMax accelerator without external intervention or signaling. Moreover, the FSM efficiently configures the arithmetic blocks and/or processing paths for the different phases (e.g., using multiplexers or MUXes) to perform the relevant operations to the given phase. In addition, the phases can be performed without corrupting the output data generated by the matrix-to-matrix operation in the memory.

The SoftMax accelerator can run in-line with a matrix-to-matrix multiplication engine, or a convolution engine. The SoftMax accelerator can operate in parallel with the matrix-to-matrix multiplication engine to perform accumulation of exponentials used for calculating the denominator value on-the-fly while the matrix-to-matrix operations are in-flight. Because of the in-line data path and parallel operation, the SoftMax accelerator avoids memory reads/writes associated with calculating the denominator. Saving memory reads/writes can in turn lead to saving a significant amount of power, because memory transactions contribute significantly to the total power consumption of a DNN accelerator.

Besides adding a hardware SoftMax accelerator that can receive output data in-line from the matrix-to-matrix multiplication core, the instruction set architecture for a DNN accelerator or compute processing device can be extended to include one or more special instructions to drive and invoke the hardware SoftMax accelerator. The special instruction can include information or details for the SoftMax accelerator to execute SoftMax, e.g., including information for configuring the memory controller and one or more finite state machines.

One important advantage of the hardware SoftMax accelerator is that it can offer significant power, performance, and area benefits when compared to LUT-based solutions. The pipelined design having two phases, where the denominator phase can operate in-line with the matrix-to-matrix multiplication core, provides a streaming behavior. In addition, the SoftMax accelerator employ low power design techniques, such as using the reciprocal only once, and gating one of the processing paths while a counterpart processing path is in use. These techniques can present power saving opportunities. At the same time, the SoftMax accelerator does not compromise accuracy through approximation. In some implementations, the arithmetic components of the compute block can be readily implemented using hardware libraries. In some cases, one or more arithmetic components can be custom designed and can be used to increase accuracy and address overflows.

In some embodiments, the SoftMax accelerator can be replicated to increase throughput and availability of the SoftMax accelerator being available to perform at least a part of the SoftMax operation in-line. In some embodiments, the exponential and the adder in the compute block of the SoftMax accelerator can be replicated to increase the throughput of the denominator phase. In some embodiments, the exponential and the multiplier in the compute block of the SoftMax accelerator can be replicated to increase the throughput of the numerator phase.

### Transformer-Based Neural Networks or Transformer-Based Models

A transformer-based neural network may include one or more blocks. A block may be an encoder. A block may be a decoder. There can be many encoder blocks and decoder blocks in the transformer-based neural network.

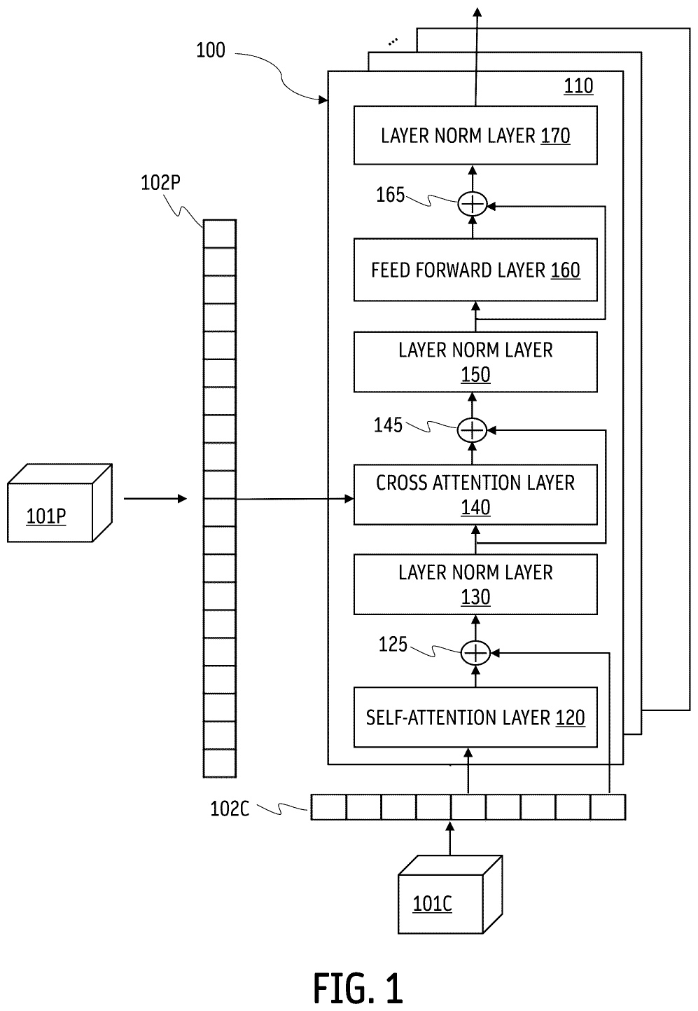

FIG. 1 illustrates block 100 in a transformer-based neural network, according to some embodiments of the disclosure. For illustration, block 100 is a decoder block in a transformer-based neural network. The transformer block 100 includes transformer decoders 110, individually referred to as “transformer decoder 110.” As an example, each transformer decoder 110 can include a plurality of layers, such as self-attention layer 120, layer norm layer 130, cross attention layer 140, another layer norm layer 150, feed forward layer 160, and another layer norm layer 170. In other embodiments, a transformer decoder 110 may include different, fewer, or more layers. The transformer block 100 may include a different number of transformer decoders 110.

Self-attention layer 120 or cross attention layer 140 may have an attention function. In some embodiments, an attention function may map one or more queries and one or more key-value pairs to an output, where the query, each key, each value, or the output may be a tensor, such as a vector. The output may be computed as a weighted sum of the values. The weight assigned to each value may be computed by a compatibility function of the query with the corresponding key. Layer norm layer 130 may connect all positions with a constant number of sequentially executed operations. Self-attention, sometimes called intra-attention, may be an attention mechanism relating different positions of a single sequence in order to compute a representation of the sequence. Self-attention layer 120 may allow each position in the corresponding transformer decoder 110 to attend to all positions in the transformer decoder 110 up to and including that position.

As shown in FIG. 1, self-attention layer 120 receives vector 102C. The vector 102C may be generated by flattening current feature map 101C. In some embodiments, current feature map 101C may be a 2D or 3D tensor, while vector 102C may be a 1D tensor. The data points in current feature map 101C may be rearranged so that the data points are all in one dimension to generate vector 102C. In an example, current feature map 101C may have three dimensions: X, Y, and Z, in which the Z dimension may be the channel dimension. The data points of current feature map 101C may be rearranged to be all in one of the X, Y, and Z dimensions to form vector 102C. Vector 102C is input into the self-attention layer 120 and may be used as the query, keys, and values of the self-attention function. In some embodiments, the self-attention function in self-attention layer 120 may be denoted as:

$$f ( Q , K , V ) = σ ( \frac{{QK}^{T}}{\sqrt{{d}_{k}}} ) V \qquad ( eq . 4 )$$

where Q, K, V denotes the query, keys, and values, respectively; f(Q, K, V) denotes the self-attention function; and σ denotes a SoftMax function or operation, as previously illustrated in equation 1 and equation 2.

The output of self-attention layer 120 is further accumulated with vector 102C by concatenator 125. The result of the concatenation is input into layer norm layer 130. Layer norm layer 130 applies a layer normalization operation on the output of concatenator 125. Layer norm layer 130 may normalize its input (i.e., the output of concatenator 125) across the feature dimension (instead of the batch dimension). The feature dimension may be the dimension of vector 102C or vector 102P.

In some embodiments, the layer normalization operation may include a sequence of computations. Layer norm layer 130 may include a mean computation, which may be denoted as

$${μ}_{xy} = \frac{1}{Z} \times {\sum }_{z = 1}^{Z} {A}_{xyz} ,$$

where A_{xyz} denotes a data element in the input tensor, x may be the positional index of the data element in one of the spatial dimensions, y may be the positional index of the data element in the other one of the spatial dimensions, z may be the positional index of the data element in the channel dimension, and μ_{xy} denotes the output of the mean computation, which may be a 2D matrix. The mean computation may be channel-wise reduction operation. Layer norm layer 130 may convert μ_{xy} to a 3D tensor μ_{xyz}, e.g., by replicating every data element over z output points.

Layer norm layer 130 may also include an elementwise subtraction, which may be denoted as D_{xyz}=A_{xyz}−μ_{xyz}. Layer norm layer 130 may also perform a variance computation, which may be denoted as σ_{xy}²=Σ_{z=1}^{Z}D_{xyz}². Layer norm layer 130 may further include a division computation denoted as

$${M}_{xy} = \frac{1}{\sqrt{\frac{1}{Z} \times ( {{σ}^{2}}_{xy} + ϵ \times Z )}} .$$

M_{xy} may be a 2D tensor. Layer norm layer 130 may also convert M_{xy} to a 3D tensor M_{xyz}, e.g., by replicating every data element over z output points. Further, layer norm layer 130 may have an element multiplication denoted as

$${{A}^{′}}_{xyz} = \frac{{A}_{xyz} - {μ}_{xyz}}{\sqrt{\frac{1}{Z} \times ( {{σ}^{2}}_{xy} + ϵ )}} = ( {A}_{xyz} - {μ}_{xyz} ) \times \frac{1}{\sqrt{\frac{1}{Z} \times ( {{σ}^{2}}_{xy} + ϵ )}} = {D}_{xyz} \times {M}_{xyz} .$$

Layer norm layer 130 may further compute

$${{A}^{″}}_{xyz} = {{A}^{′}}_{xyz} + \frac{{β}_{z}}{{γ}_{z}} and {LN}_{xyz} = {{A}^{″}}_{xyz} \times {γ}_{z} \cdot {LN}_{xyz}$$

may be the output of the layer normalization operation.

The output of layer norm layer 130, which encodes the flattened current feature, may be input into cross attention layer 140. Cross attention layer 140 also receives vector 102P as another input. Vector 102P is generated by flattening previous feature maps such as previous feature map 101P. Previous feature map 101P may be generated by an encoder block of the transformer-based neural network. In some embodiments, a previous feature map 101P may be a 2D or 3D tensor, while vector 102P may be a 1D tensor. The data points in previous feature maps 101P may be rearranged so that the data points are all in one dimension to generate vector 102P. In an example, each previous feature map 101P may have three dimensions: X, Y, and Z, in which the Z dimension may be the channel dimension. The data points of previous feature maps 101P may be rearranged to be all in one of the X, Y, and Z dimensions to form vector 102P. The data points in the same previous feature map may be arranged together, e.g., in a manner that is not interrupted by any data points in a different previous feature map. In some embodiments, vector 102P is in the same dimension as vector 102C. Vector 102C and vector 102P are each represented by a sequence of boxes in FIG. 1 for the purpose of illustration. The number of boxes in vector 102C or vector 102P does not represent the number of data points in vector 102C or vector 102P. In some embodiments, the number of data points in vector 102C may equal the number of data points in the current feature map 101C, and the number of data points in vector 102P may equal the total number of data points in all the previous feature maps 101P.

Cross attention layer 140 has a cross attention function that is applied on vector 102P and vector 102C. Vector 102P may be used as the query, and vector 102C may be used as the keys and values. The cross attention function may be denoted as:

$${f}_{CA} ( {s}_{t} , {s}_{p} ) = σ ( \frac{( {s}_{t} {W}^{Q} ) {( {s}_{p} {W}^{K} )}^{T}}{\sqrt{C}} ) ( {s}_{p} {W}^{V} ) \qquad ( eq . 5 )$$

where σ is the SoftMax function or operation as illustrated in equation 1 and equation 2; sₜ∈ [symbol] ^{(HW)×C} denotes the vector 102C; sₚ∈ [symbol] ^{(N}^{_{F}}^{HW)×C} denotes vector 102P; and W^{Q}, W^{K}, W^{V}∈ [symbol] ^{C×C} are projection matrices for query, keys, and values respectively.

The output of cross attention layer 140 may be accumulated with the output of layer norm layer 130 by another concatenator 145. The output of concatenator 145 is input into layer norm layer 150 for performing another layer normalization operation in layer norm layer 150. The output of layer norm layer 150 is input into feed forward layer 160. In some embodiments, feed forward layer 160 may include a linear transformation and a nonlinear transformation. The linear transformation may be the same or similar to the operation in a fully connected layer. The nonlinear transformation may be an activation function. In some embodiments, feed forward layer 160 may multiply the input with keys to get a weight for each key. Feed forward layer 160 may compute a weight sum of the values using the weights to produce the output.

The output of feed forward layer 160 may be accumulated with the output of layer norm layer 150 by a concatenator 165. The output of the concatenator 165 may be input into layer norm layer 170 in which another layer normalization operation is performed. The output of layer norm layer 170 may be input into the next transformer decoder 110 for further processing. The output of the last transformer decoder 110 may constitute the output of the transformer block 100, which may be an intermediate feature map that represents an aggregation of the current feature map 101C and the previous feature maps 101P.

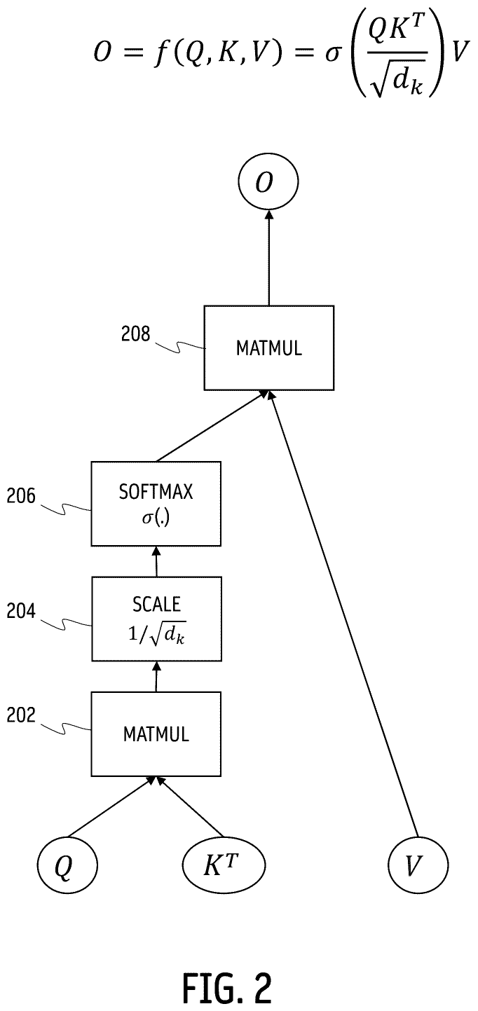

FIG. 2 illustrates operations in an attention layer, according to some embodiments of the disclosure. For a transformer-based neural network, the attention layer (e.g., a self-attention layer, a cross attention layer, a multi-head attention layer, a masked multi-head attention layer) can be included in an encoder block. The attention layer, e.g., self-attention layer 120 and cross attention layer 140 of FIG. 1, can be included in a decoder block.

To perform at least some of the operations associated with an attention mechanism, the attention layer would include operations such as MatMul, a scaling operation, and a SoftMax function or operation. To illustrate, operations for computing values based on equation 4 are depicted in FIG. 2.

The attention layer may include MatMul operation 202. MatMul operation 202 may multiply matrix Q and matrix K^{T} to calculate QK^{T}.

The attention layer may include scale operation 204. Scale operation 204 may scale values of QK^{T} (output tensor of MatMul operation 202) by 1/\sqrt{dₖ} to calculate

$$\frac{{QK}^{T}}{\sqrt{{d}_{k}}} .$$

The attention layer may include SoftMax operation 206. SoftMax operation 206 may apply the SoftMax function on

$$\frac{{QK}^{T}}{\sqrt{{d}_{k}}}$$

(output tensor of scale operation 204) to calculate

$$σ ( \frac{{QK}^{T}}{\sqrt{{d}_{k}}} ) .$$

SoftMax operation 206 may convert the output of scale operation 204 into a matrix of probabilities, or attention scores. SoftMax operation 206 may perform the calculations illustrated in equation 1 and equation 2, taking

$$\frac{{QK}^{T}}{\sqrt{{d}_{k}}}$$

as the input tensor.

The attention layer may include MatMul operation 208. MatMul operation 208 may multiply matrix σ

$$( \frac{{QK}^{T}}{\sqrt{{d}_{k}}} )$$

(output tensor of SoftMax operation 206) and matrix V to calculate output

$$O = f ( Q , K , V ) = σ ( \frac{{QK}^{T}}{\sqrt{{d}_{k}}} ) V .$$

MatMul operation 208 combines the matrix of probabilities or attention scores with the value tensor V.

The output of MatMul operation 208 may be passed on to a next layer, such as a layer norm layer in a transformer block.

In practice, the attention layer may include many instances of the operations illustrated in FIG. 2 in parallel. For a self-attention layer, SoftMax operation 206 may be applied to calculate b×K times, where b is batch size, and K is sequence length. K may also be the size of the input tensor to SoftMax operation 206. K may also be the size of the output tensor of SoftMax operation 206. For a multi-head attention layer, SoftMax operation 206 may be applied to calculate b×h×K times, where b is batch size, h is the number of heads, and K is sequence length.

The operations illustrated in FIG. 2 for an attention layer implements a self-attention mechanism. The attention layer has operations that can perform at least some of the calculations for computing values based on equation 4. The operations illustrated in FIG. 2 can be implemented to perform cross attention or other attention mechanisms as well. The attention layer has operations that can perform at least some of the calculations for computing values based on equation 5.

### Examples of Neural Networks where SoftMax is Used

In some cases, such as the cases illustrated in FIG. 2, a SoftMax operation may be implemented in an attention layer of a transformer-based neural network. The SoftMax operation may follow a scale operation in the attention layer. The SoftMax operation is used in the attention mechanism or the attention layer of transformer-based neural networks because the SoftMax operation helps to determine the importance weights or attention scores assigned to each element in the input sequence when computing the weighted sum of the value vectors. In the attention layer of a transformer-based neural network, the input to the attention layer includes queries, keys, and values, which are derived from the input sequence. The attention scores are computed as a scaled dot product between the query and key vectors, which represent the relevance between the query and each key. However, these attention scores are not necessarily normalized and may have values outside the range of 0 to 1. The SoftMax operation is applied to these attention scores to convert them into a probability distribution, where each value represents the relative importance or weight assigned to the corresponding value vector. The SoftMax operation ensures that the attention weights sum up to 1, which is a desirable property for a probability distribution. The normalization functionality of the SoftMax operation applied in this manner prevents the attention mechanism from assigning excessive importance to a single element or position in the input sequence, which could lead to unstable or biased representations. By applying the SoftMax operation, the attention weights are transformed into a well-behaved probability distribution, allowing the attention mechanism to distribute the importance weights more evenly across the relevant elements of the input sequence. Furthermore, the SoftMax function is differentiable, which allows the transformer-based neural network to be trainable using gradient-based optimization techniques, such as backpropagation.

In some cases, the SoftMax operation may be implemented in an output layer of a neural network. The SoftMax operation may be provided in an output layer which follows a linear layer. The SoftMax operation may be provided in an output layer which follows one or more fully connected layers. In the context of neural networks for classification tasks, the SoftMax operation can be provided in the output layer. Each element of the input tensor (or vector of the input tensor) represents the activation value for a particular class, and the SoftMax function can convert these activation values into probabilities. The class with the highest probability may then be chosen as the predicted class. The SoftMax operation is particularly useful when dealing with multi-class classification problems because the SoftMax operation provides a way to represent the probability distribution over all classes. The SoftMax operation is also differentiable, which allows the use of gradient-based optimization techniques for training neural networks.

### Challenges in Designing DNN Accelerators and Implementing SoftMax

The significant improvements in DNN model size and accuracy coupled with the rapid increase in computing power of execution platforms have led to the adoption of DNN applications even within resource constrained mobile and edge devices that have limited power availability. DNN models may be executed, e.g., for training or inference, by DNN accelerators. A DNN accelerator may include a processing device, or a processor that is designed to accelerate execution of DNNs. A DNN accelerator may include an application-specific integrated circuit (ASIC). A DNN accelerator may include a field programmable gate array (FPGA) processor. A DNN accelerator includes integrated circuitry to execute operations of a DNN. One example of a DNN accelerator is a graphics processing unit (GPU) with parallel processing cores that can perform matrix operations of DNNs efficiently. Another example of a DNN accelerator is a tensor processing unit (TPU) that has hardware blocks to perform tensor computations with high computational throughput in large-scale machine learning settings. Yet another example of a DNN accelerator is a neural processing unit (NPU) that has hardware blocks to perform neural network computations for efficient, real-time DNN execution in edge computing settings or on-device settings.

Designing a DNN have several challenges. One challenge relates to computational efficiency, which requires balancing processing performance against power consumption. Another challenge is to create architectures flexible enough to handle diverse neural network designs. Yet another challenge relates to reducing data transfer bottlenecks and optimizing memory bandwidth, ensuring that processors can efficiently move and process information. Yet another challenge relates to precision and computational accuracy. Designs may take into account numeric precision and representation, weighing the trade-offs between computational complexity and model accuracy. Some designs may be implemented to efficiently perform floating-point (FP) and integer calculations while maintaining the balance between computational efficiency and mathematical fidelity. The list of challenges can go on.

Because SoftMax appears in many DNNs, and in some cases, SoftMax appears for many instances within a DNN, it is important for DNN accelerators to implement the SoftMax function efficiently with low power, high performance, and low area. It is not trivial to implement the SoftMax function in hardware.

### Shortcomings of LUT-Based Solutions for Implementing SoftMax

LUT-based solutions can include using an LUT for the entire SoftMax equation and applying piecewise curve fitting algorithm to fit the input onto the equation. LUT-based solutions can include using an LUT for individual complex operations of SoftMax such as exponential and reciprocal and realizing the SoftMax equation using simpler arithmetic components such as addition and multiplication. LUTs can be used to approximate a function such as SoftMax equation as illustrated in equation 1 and equation 2, an activation function, exponential, and reciprocal. The approximation can be done through piecewise approximation. In some embodiments, a function to be approximated using an LUT (e.g., SoftMax) may be bounded to an interval [−m, m](where ‘m’ is a real number). This interval is divided into number of subintervals onto which the function is approximated by a polynomial. The coefficients of these polynomials are computed and stored in an LUT. To evaluate a polynomial, such as (ax+b) or (ax²+bx+c), for any point on the curve, the coefficient values a, b and c are fetched from the LUT, and the polynomial is evaluated using multiplications and additions. The result is passed to the output. The values outside the interval of interest [−m, m] are considered for saturation or bypass operations. In case of saturation, the saturation value from LUT is passed to the output without any modification. In case of bypass, the input is passed on to the output without any modification.

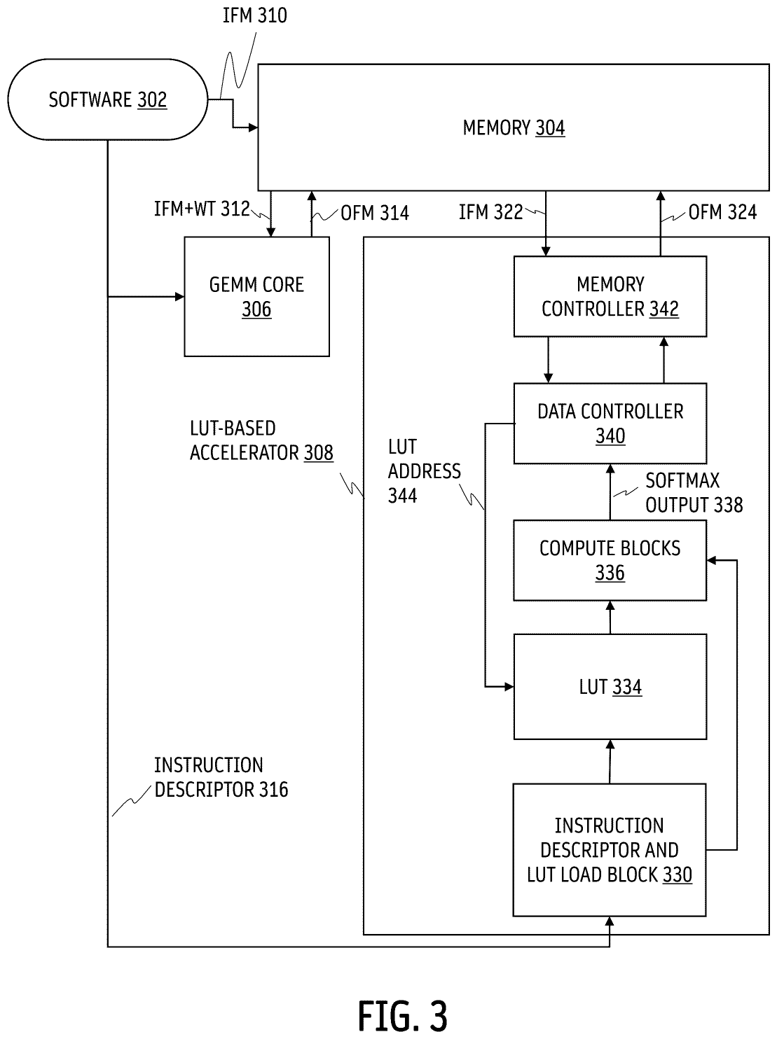

FIG. 3 illustrates hardware acceleration involving a look-up table implementation for the SoftMax operation, according to some embodiments of the disclosure. A DNN accelerator may include memory 304, GEMM core 306, and LUT-based accelerator 308. LUT-based accelerator 308 may include instruction descriptor and LUT load block 330, LUT 334, compute blocks 336, data controller 340, and memory controller 342.

Software 302 may load weights onto memory 304. Software 302 may load IFM 310 (having input feature map representing input activation data) onto memory 304.

Software 302 may send an instruction to GEMM core 306 to perform an operation, such as matrix-to-matrix multiplication. In one example, GEMM core 306 reads IFM+WT 312 (having an input feature map and weights) from memory 304. GEMM core 306 performs an operation according to the instruction. GEMM core 306 may write OFM 314 (having output feature map or output data) to memory 304.

Software 302 may send an instruction descriptor 316 to LUT-based accelerator 308. Instruction descriptor 316 may include an instruction or configuration information that specify one or more operations that LUT-based accelerator 308 is to perform. Instruction descriptor 316 may include LUT entries that correspond to the SoftMax operation. Instruction descriptor and LUT load block 330 may configure LUT-based accelerator 308 according to the instruction descriptor 316. Instruction descriptor and LUT load block 330 may load the LUT entries in instruction descriptor 316 (including saturation values, if any) onto LUT 334.

Data controller 340 may begin SoftMax operation by issuing read requests to memory 304 through memory controller 342 to read IFM 322 from memory 304. IFM 322 corresponds to OFM 314 calculated by GEMM core 306 and stored in memory 304. Once IFM 322 is read from memory 304, data controller 340 may (1) check for saturation or bypass, and (2) if not saturation or bypass, generate LUT address 344.

Using LUT address 344, LUT 334 may output values, such as coefficients for a polynomial. The output values from LUT 334 are fed to compute blocks 336. Compute blocks 336 can include basic arithmetic components such as a multiplier and an adder. Compute blocks 336 can handle 1^{st} and 2^{nd} order polynomials. Compute blocks 336 may output SoftMax output 338, which is fed to data controller 340. Via memory controller 342, write requests can be issued to memory 304 to write OFM 324 (having SoftMax output 338) to memory 304.

To apply an activation such as SoftMax, a new instruction descriptor with appropriate LUT entries is generated and sent by software 302 to load the appropriate LUT entries data onto LUT 334 though instruction descriptor and LUT load block 330. Workload overhead of such instruction descriptors is high. Offering a large LUT can significantly increase power and area. Shared (multi-ported) LUTs can be complex to implement.

In some implementations, the exponential and the reciprocal operations of SoftMax are implemented using respective LUTs, and SoftMax is realized through basic arithmetic components such as an adder, a subtractor, and a multiplier. Since these LUTs for the exponential and the reciprocal can be implemented in the extended math unit, they suffer from having a high latency penalty.

Implementing activations such as SoftMax is not trivial, because the implementation has to address one or more of the shortcomings described above.

Implementing an In-Line SoftMax Accelerator within a DNN Accelerator

The alternative to an LUT-based accelerator is to implement a hardware SoftMax accelerator that has arithmetic components to perform the operations of the SoftMax equation. However, implementing the hardware SoftMax accelerator to perform the operations can mean that latency can be high because of the complexity of the SoftMax operations and the amount of memory transactions. To address the latency issue, the SoftMax operations are decomposed into two execution phases: a denominator phase and a numerator phase. During the denominator phase, the hardware SoftMax accelerator does not read any data from memory but instead consumes the output data produced by GEMM core directly, where the output data is received via an in-line data path. The SoftMax accelerator performs accumulations after taking the exponentials of the output data. At the end of the denominator phase, the reciprocal of the accumulated value can be computed and stored in a local register of the SoftMax accelerator. During the numerator phase, the SoftMax accelerator starts reading the output data written by the GEMM core from the memory. In the numerator phase, the exponential of the output data is (re-)computed and is then multiplied with the reciprocal of denominator (which is stored in the local register) to generate a SoftMax output. The SoftMax outputs can be written to the memory. This means that hardware SoftMax accelerator can operate to produce partial results during the denominator phase while the GEMM core operations are in-flight, and half of the memory transactions are avoided because the output data is received via an in-line data path. Implementing the in-line SoftMax accelerator is not trivial, and the following passages illustrate some of the challenges involved and solutions that can address them.

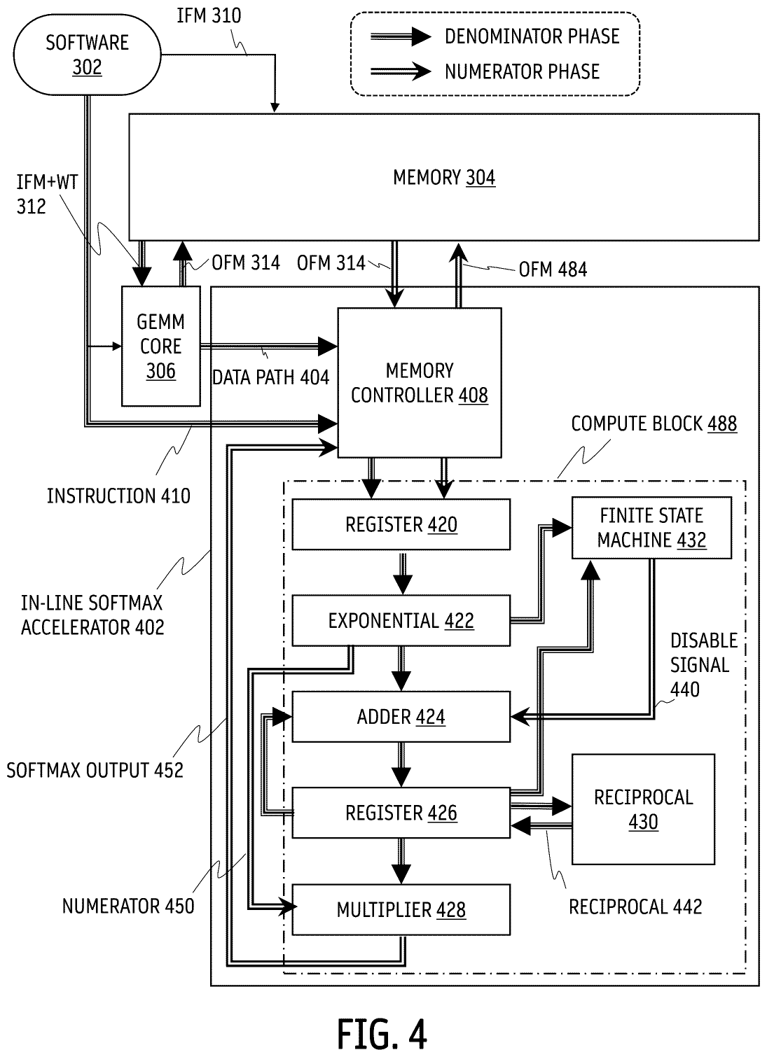

FIG. 4 illustrates hardware acceleration involving partial in-line execution of SoftMax, according to some embodiments of the disclosure. A DNN accelerator includes memory 304, GEMM core 306 (or matrix-to-matrix multiplication core), and in-line SoftMax accelerator 402. The DNN accelerator may be an integrated circuit, such as a system-on-chip integrated circuit. The DNN accelerator may have one or more memories (e.g., including memory 304) and one or more processing cores (e.g., including GEMM core, in-line SoftMax accelerator 402).

GEMM core 306 may perform matrix multiplication and generate output values of an output tensor. GEMM core 306 may perform convolution, such as convolution of IFM with weights or a kernel, and generate output data having values of OFM. GEMM core 306 may perform matrix-to-matrix multiplication based on input tensors read from memory 304 and writes output data having values of an output tensor to memory 304. GEMM core 306 may have one or more memory read lines to read input data from memory 304. GEMM core 306 may have one or more memory write lines to write output data computed by GEMM core 306 to memory 304. For illustration, GEMM core 306 may perform convolution based on IFM+WT 312 read from memory 304 on one or more memory read lines and generate OFM 314. GEMM core 306 may compute output values of OFM 314 and write the output values of OFM 314 on one or more memory write lines to memory 304.

In-line SoftMax accelerator 402 includes an in-line data path 404 to receive output data from GEMM core 306. The output data may include one or more output values generated by GEMM core 306. In-line data path 404 allows output data to be passed, transmitted, or sent from a GEMM core 306 to in-line SoftMax accelerator 402. In-line data path 404 can be used to send output data to in-line SoftMax accelerator 402 for processing and bypass memory 304. In-line data path 404 may include one or more wires that directly connect GEMM core 306 to in-line SoftMax accelerator 402. In some cases, in-line data path 404 may include the one or more wires that tap one or more memory write lines GEMM core 306 to pass the output data being written to memory 304 onto in-line SoftMax accelerator 402 (before the output data reaches memory 304).

In-line SoftMax accelerator 402 includes compute block 488 to perform arithmetic operations of SoftMax (e.g., to realize the SoftMax operation illustrated in equation 1 and equation 2). Compute block 488 can include one or more registers, one or more arithmetic components, and finite state machine 432.

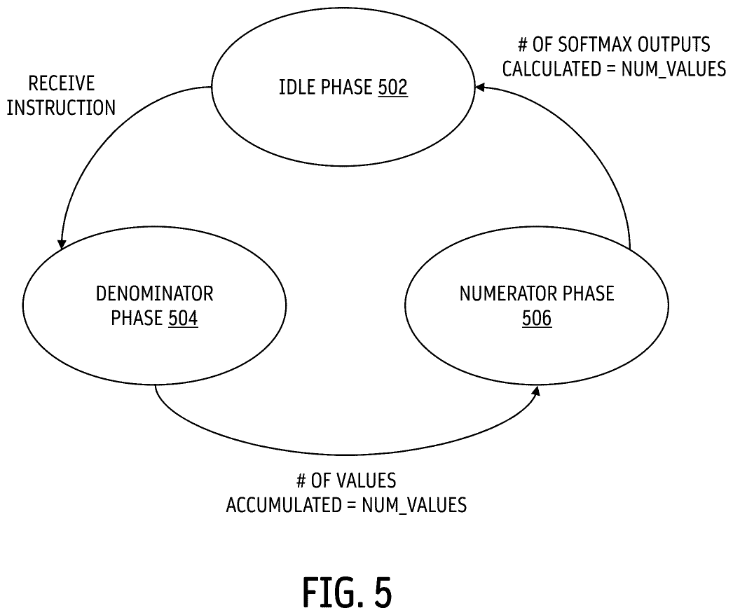

Finite state machine 432 may serve as a controller to configure components of compute block 488 to perform SoftMax in different phases (e.g., denominator phase, numerator phase). Finite state machine 432 may maintain a state and monitor conditions which may trigger a change in state or transition to a different state. Finite state machine 432 may keep track of a number of values processed by a component of compute block 488. Finite state machine 432 may keep track of whether accumulation is completed. Finite state machine 432 may keep track of whether a reciprocal is calculated. Finite state machine 432 may keep track of a number of SoftMax outputs calculated or computed by compute block 488. Finite state machine 432 may keep track of the progress of computing SoftMax. Finite state machine 432 keeps track of the processing being performed by in-line SoftMax accelerator 402 without intervention from software 302. Finite state machine 432 may have an idle phase, a denominator phase, and a numerator phase. Exemplary state transition diagram of finite state machine 432 is illustrated in FIG. 5.

Referring back to FIG. 4, in-line SoftMax accelerator 402 includes memory controller 408 to provide the output data received via in-line data path 404 to compute block 488. Memory controller 408 may write one or more SoftMax outputs generated by compute block 488 to memory 304.

The one or more registers of compute block 488 may include register 420. In a denominator phase, register 420 may store an output value generated by GEMM core 306 received via in-line data path 404. Memory controller 408 may provide the output value received via in-line data path 404 to register 420 of compute block 488. In a numerator phase, register 420 may store an output value generated by GEMM core 306 received from memory 304. Memory controller 408 may provide the output value read from memory 304 to register 420 of compute block 488.

The one or more registers of compute block 488 may include register 426. In a denominator phase, register 426 may store an accumulated value. At the end of the denominator phase, register 426 may store a reciprocal of the accumulated value. In a numerator phase, register 426 may store the reciprocal.

The one or more arithmetic components (e.g., hardware circuitry that performs one or more arithmetic operations) may include one or more of: exponential 422, adder 424, multiplier 428, and reciprocal 430. Finite state machine 432 may configure the arithmetic components to perform arithmetic operations of SoftMax.

Software 302 may send or transmit instruction 410 to invoke in-line SoftMax accelerator 402 to perform SoftMax. Instruction 410 may be sent or transmitted to memory controller 408. Memory controller 408 may decode instruction 410 and configure one or more components in in-line SoftMax accelerator 402 according to instruction 410. Memory controller 408 may initiate or reset one or more counter in finite state machine 432. Memory controller 408 may set or load one or more values in finite state machine 432 (for comparing with a value in a counter). Memory controller 408 may control one or more components in in-line SoftMax accelerator 402 to operate in one of the operating phases: a denominator phase, and a numerator phase.

Finite state machine 432 of in-line SoftMax accelerator 402 may start in an idle phase. In response to receiving instruction 410 for execution by in-line SoftMax accelerator 402, finite state machine 432 may transition to the denominator phase. In the case where instruction 410 enables at least partial in-line execution of SoftMax with GEMM core 306, memory controller 408 reads the output data (e.g., having OFM data) from GEMM core 306 via in-line data path 404. Finite state machine 432 may enable a processing path having or through adder 424 during the denominator phase.

Memory controller 408 takes the output data received via in-line data path 404 through compute block 488, e.g., through a processing path involving register 420, exponential 422, adder 424, and register 426. The processing path calculates a sum of the exponentials, e.g., corresponding to Σⱼ₌₁^{K}e^{z}^{ⱼ} of equation 3. Specifically, an output value of the output data may be stored in register 420. Exponential 422 may determine an exponential of the output value in register 420, e.g., corresponding to e^{z}^{ⱼ} of equation 3. Adder 424 may add the computed exponential from exponential 422 to an accumulated value in register 426 to calculate a running sum of the exponentials and store the running sum in register 426. Finite state machine 432 may configure one or more further output values received via in-line data path 404 to be loaded on register 420 and to be processed by exponential 422 and adder 424. Upon accumulating K exponentials, register 426 may store the sum of the exponentials, e.g., corresponding to Σⱼ₌₁^{K}e^{z}^{ⱼ} of equation 3. Finite state machine 432 can keep track of how many output values in the output data are processed by the processing path, and how many are yet to be processed by the processing path. In response to finite state machine 432 determining that all K exponentials are accumulated through adder 424 or determining adder 424 has performed a number of additions (e.g., K additions), finite state machine 432 disables the processing path having or through adder 424. Finite state machine 432 may disable the processing path through adder 424 using disable signal 440. Finite state machine 432 causes the accumulated value in stored in register 426 be forwarded to reciprocal 430. Reciprocal 430 computes the reciprocal of the accumulated value to compute

$$\frac{1}{{\sum }_{j = 1}^{K} {e}^{{z}_{j}}}$$

of equation 3. The reciprocal value (shown as reciprocal 442) is then stored back into register 426 to complete the denominator phase. Finite state machine 432 may determine that the reciprocal is calculated and transitions to the numerator phase.

The operations in the denominator phase can be performed in-line with GEMM core 306 without requiring any data from memory 304. In some implementations, the one or more arithmetic components can utilize standard arithmetic components from hardware libraries and do not use LUTs for performing arithmetic operations. Since the power requirements for performing the division operations of SoftMax (as illustrated in equation 1 and equation 2) are significantly higher than other compute operations, compute block 488 advantageously computes the reciprocal

$$( \frac{1}{{\sum }_{j = 1}^{K} {e}^{{z}_{j}}} )$$

once, and use multiplier 428 to perform division. In other words, a division operation present in the SoftMax equation illustrated in equation 1 and equation 2 is realized by means of a reciprocal operation and a multiplication operation. In the overall SoftMax execution, reciprocal 430 is used only once, e.g., at the end of the denominator phase or while switching between the denominator and numerator phases.

The numerator phase begins as soon as denominator phase ends. In other words, finite state machine 432 transitions from the denominator phase to the numerator phase. Memory controller 408 may switch compute block 488 connections from the denominator phase paths (denoted by a triple lined arrow) to the numerator phase paths (denoted by a double lined arrow). During the numerator phase, memory controller 408 takes the output data (of OFM 314) received from memory 304 through compute block 488, e.g., through a processing path involving register 420, exponential 422, register 426, and multiplier 428. The processing path calculates the SoftMax outputs (e.g.

$$\frac{{e}^{{z}_{i}}}{{\sum }_{j = 1}^{K} {e}^{{z}_{j}}}$$

of equation 2). Specifically, an output value of OFM 314 read from memory 304 may be stored in register 420. Exponential 422 may determine an exponential of the output value in register 420, e.g., corresponding to e^{z}^{ᵢ} of equation 2 (shown as numerator 450). The exponential value (e^{z}^{ᵢ}) is then multiplied by multiplier 428 with the reciprocal value stored in register 426

$$( \frac{1}{{\sum }_{j = 1}^{K} {e}^{{z}_{j}}} )$$

to compute SoftMax output 452 (e.g.,

$$\frac{{e}^{{z}_{i}}}{{\sum }_{j = 1}^{K} {e}^{{z}_{j}}}$$

of equation 2). Memory controller 408 may write SoftMax output 452 to memory 304 as part of OFM 484. Finite state machine 432 can keep track of how many output values in the output data are processed by the processing path, and how many are yet to be processed by the processing path. In response to finite state machine 432 determining that all K SoftMax outputs are produced and written to memory 304 as OFM 484, or that multiplier 428 has performed a number of multiplications (e.g., K multiplications), finite state machine 432 can enable the processing path having or through adder 424 and the numerator phase is completed. Finite state machine 432 may transition back to an idle phase.

Memory controller 408 may receive instruction 410 to perform at least a part of SoftMax (as illustrated by equation 1 and equation 2) in-line with GEMM core 306. Memory controller 408 may decode instruction 410 and extract information for the functioning of in-line SoftMax accelerator 402. In some cases, instruction 410 may include a variable or value to indicate standalone execution of SoftMax or at least partial in-line execution of SoftMax. In some cases, instruction 410 may include one or more of: an output base address of the memory at which one or more SoftMax outputs generated by the compute block is to be written, an input base address of the memory from which the output data generated by the matrix-to-matrix multiplication core is to be read, and a value specifying an amount of the output data from the in-line data path that the SoftMax accelerator is to process.

For example, instruction 410 can include: SFTMAX, “SoftMax operation with X type”, where the X is a variable indicating whether to enable SoftMax with at least partial in-line with GEMM core such as memory 304 (X==1) or invoked to perform standalone SoftMax (X==0). Variable X can take either 0 (for standalone execution) or 1 (enabled in-line with GEMM core). For example, to execute SoftMax function in-line with GEMM core can be given as: SFTMA1, while for standalone version: SFTMA0.

The format of instruction 410 can include: SFTMAX tdest, tsrc1, #immediate. tdest can hold the output base address to the memory where SoftMax outputs will be written back. tsrc1 can hold the input base address of the input data (e.g., OFM 314 in memory 304) in the memory (e.g., memory 304). The number of output values (e.g., size of the input vector to SoftMax, or K) for which the SoftMax accelerator is to process (received via in-line data path 404 or from memory 304) are passed through an immediate value, #immediate. Memory 304 can determine and populate the information in instruction 410.

FIG. 5 illustrates states of a finite state machine, according to some embodiments of the disclosure. In particular, FIG. 5 depicts a state transition diagram for finite state machine 432 of FIG. 4. Finite state machine 432 may have idle phase 502, denominator phase 504, and numerator phase 506. Finite state machine 432 may be in idle phase 502. In response to receiving an instruction to perform SoftMax, finite state machine 432 may transition from idle phase 502 to denominator phase 504. In response to determining that a number of values have been accumulated in a local register (or that a reciprocal of the accumulated value has been calculated and stored in the local register), finite state machine 432 may transition from denominator phase 504 to numerator phase 506. In response to determining that a number of SoftMax outputs have been calculated, finite state machine 432 may transition from numerator phase 506 to idle phase 502.

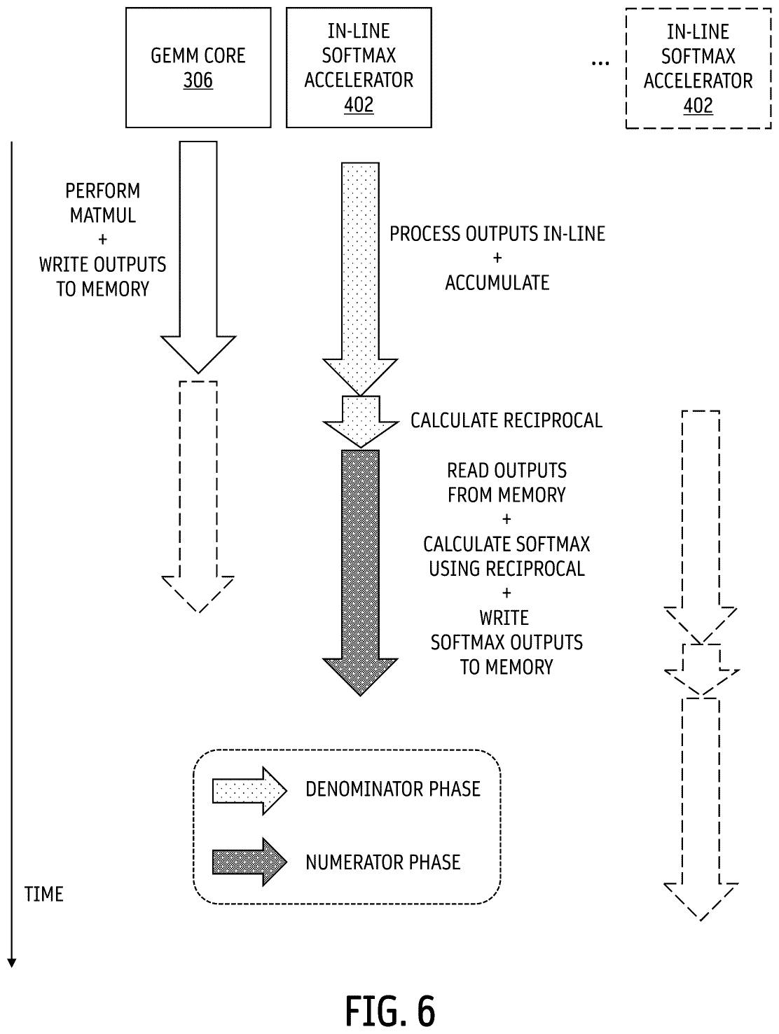

FIG. 6 illustrates timing of performing matrix-to-matrix multiplication operations and performing a part of SoftMax in-line with the matrix-to-matrix multiplication operations, according to some embodiments of the disclosure. It can be seen the in-line SoftMax accelerator 402 may process outputs of GEMM core 306 in-line, while GEMM core 306 is performing MatMul and writing outputs to memory. The parallel operation enabled by the pipelined operation of in-line SoftMax accelerator 402 during the denominator phase of in-line SoftMax accelerator 402 can significantly reduce overall latency of DNN execution.

In some embodiments, in-line SoftMax accelerator 402 may be replicated for GEMM core 306. Adding a further in-line SoftMax accelerator 402 that can receive outputs in-line from GEMM core 306 can mean that when GEMM core 306 is performing a further MatMul whose outputs are to go through a further SoftMax operation, the further in-line SoftMax accelerator 402 can process further outputs in-line from GEMM core 306 as GEMM core 306 is performing the further MatMul (while in-line SoftMax accelerator 402 is busy completing the numerator phase). Replicating in-line SoftMax accelerator 402 can increase throughput and availability of one or more SoftMax accelerators being available to perform at least a part of the SoftMax operation in-line.

In some embodiments, the processing path through exponential 422 and adder 424 in compute block 488 of in-line SoftMax accelerator 402 can be replicated to increase the throughput of the denominator phase. Multiple parallel processing paths can compute exponentials in parallel, and the exponentials can be accumulated in register 426.

In some embodiments, the processing path through exponential 422 and and multiplier 428 in compute block 488 of in-line SoftMax accelerator 402 can be replicated to increase the throughput of the numerator phase. Multiple parallel processing paths can compute exponentials and perform multiplication in parallel to produce SoftMax outputs.

### Addressing Overflow in the Compute Block of the SoftMax Accelerator

Two numeric issues may arise when computing SoftMax outputs according to the methodology illustrated in FIG. 4. The issues may include one or more of: (A) the sum of exponentials being accumulated during the denominator phase may overflow, and (B) the terms exp(z[i]), or e^{z}^{ᵢ}, may overflow the floating-point format (e.g., IEEE-754 floating-point format).

A number represented by floating-point format can include three components or parts: a sign bit (indicates if the number is positive or negative), an exponent part (indicates where the binary point floats, and a mantissa part (a significand or holds the binary digits). In IEEE-754 standard, single-precision floating-point numbers (32 bits) may be represented by [1 bit: sign][8 bits: exponent][23 bits: mantissa], and double precision floating-point numbers (64 bits) may be represented by [1 bit: sign][11 bits: exponent][52 bits: mantissa]. The number can be calculated as: (−1)^{sign}×2∧(exponent−bias)×1.mantissa. Bias is 127 for single-precision and 1023 for double precision. Mantissa is normalized so that the first digit is always 1.

In addressing issue (A), it is possible to apply scaling to scale back the accumulated value so that no overflow occurs. To prevent accumulator overflows, it is possible to detect whether overflow is expected, and if so, the accumulated value can be scaled back by a scale factor, and the running scale factor can be stored in a separate register in the SoftMax accelerator.

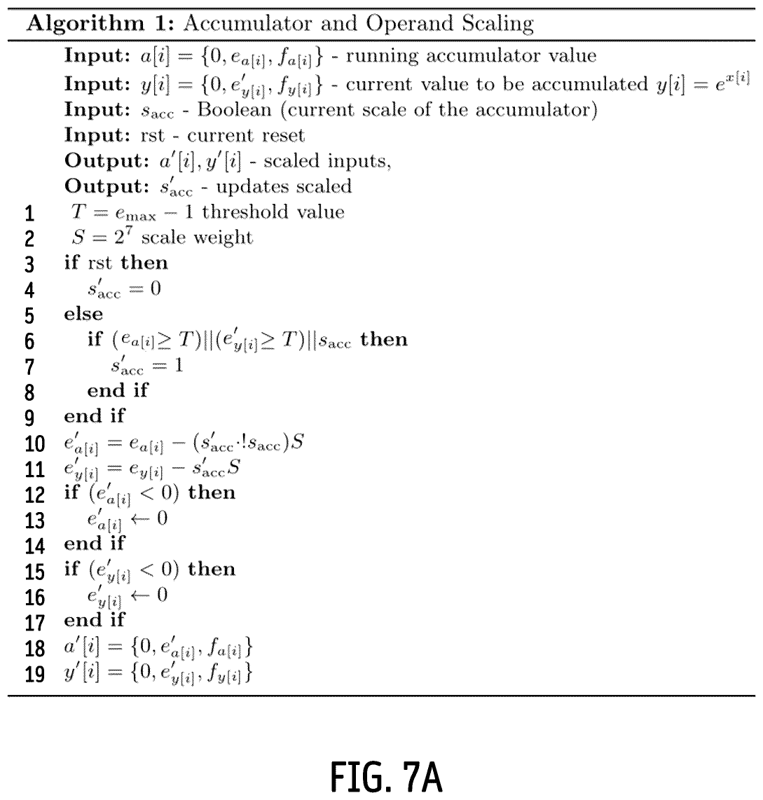

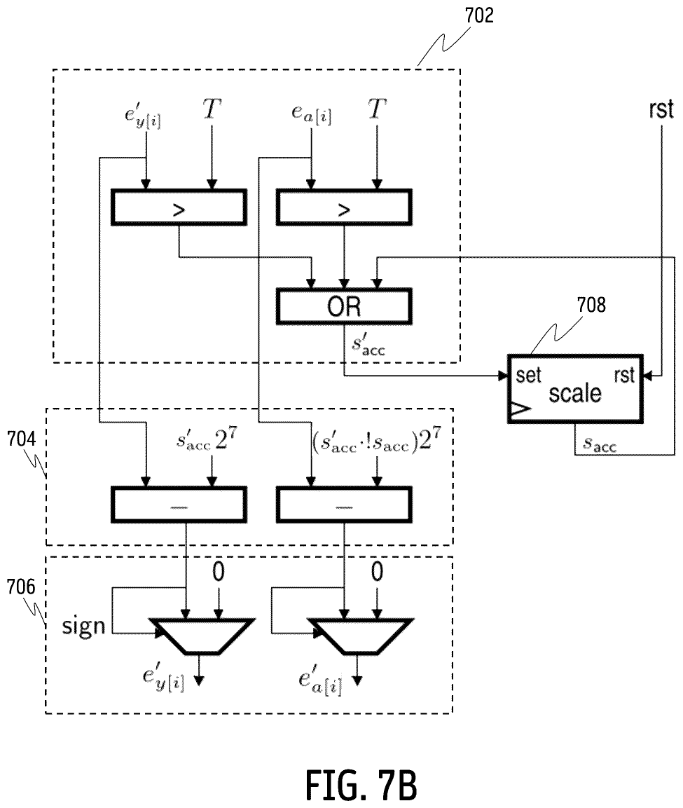

FIG. 7A illustrates an algorithm for handling scaling, according to some embodiments of the disclosure. FIG. 7B illustrates hardware logic for handling scaling, according to some embodiments of the disclosure. a[i] denotes the current accumulator value (e.g., as stored in register 426 of FIG. 4). y[i]=e^{z}^{ᵢ} denotes the current exponential to be accumulated. If the accumulated value (e.g., sum of the two inputs, a[i] and y[i]) potentially overflows the format, the accumulated value is shifted back into the representable range.

If one or both of the exponent part of the two inputs a[i] and y[i] are above an exponent threshold T, then both operands may be scaled back so that the sum does not overflow the format. For single-precision, the exponent threshold T may be (in binary) 11111110. Line 6 of the algorithm shown in FIG. 7A (logic in 702 of FIG. 7B implements line 6 of the algorithm) may perform the check against the exponent threshold.

In lines 10-11 of the algorithm shown in FIG. 7A (logic in 704 of FIG. 7B implements lines 10-11 of the algorithm), a large value is subtracted out of the biased exponents. One choice for this large value is 2⁷⁼¹²⁸ (a power of two with many trailing zeros), since the subtraction of a power of two translates into a cheap hardware operation. Subtraction is very cheap with this constant since the subtraction only operates on the most significant bits of the exponent.

In lines 12-17 of the algorithm shown in FIG. 7A (logic in 706 of FIG. 7B implements lines 12-17 of the algorithm), an exponent is pushed to 0 if the exponent becomes negative.

Once the scaling has been performed, the scale factor for the accumulated value, or scaling value is stored in a register, e.g., scale register 708 of FIG. 7B.

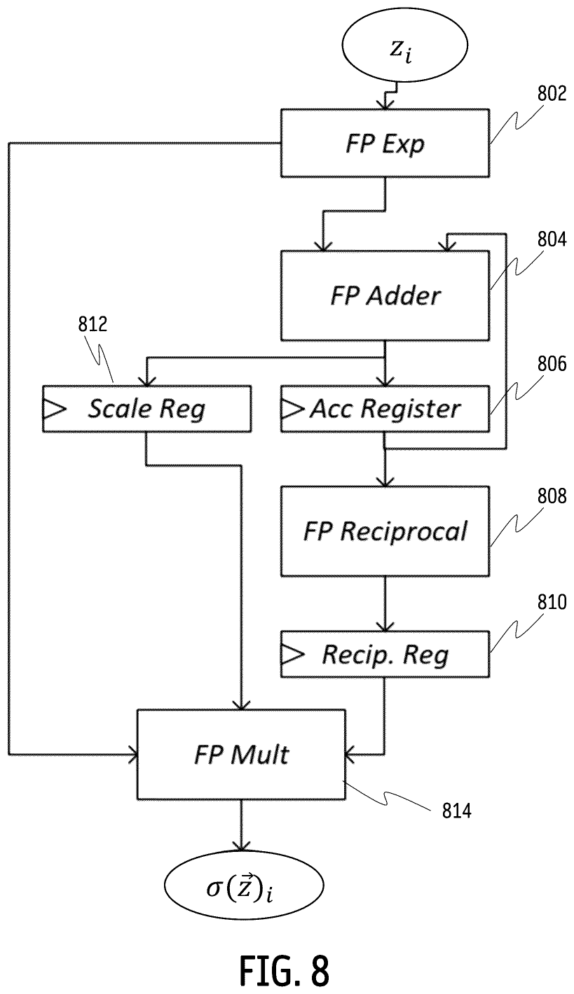

FIG. 8 illustrates hardware components in an exemplary SoftMax accelerator, according to some embodiments of the disclosure. The SoftMax accelerator may calculate

$${σ ( \vec{z} )}_{i} = \frac{{e}^{{z}_{i}}}{{\sum }_{j = 1}^{K} {e}^{{z}_{j}}}$$

based on zᵢ. The SoftMax accelerator may include FP exponential 802, FP adder 804, register 806, FP reciprocal 808, register 810, and FP multiplier 814. FP exponential 802 may correspond to exponential 422 of FIG. 4. FP adder 804 may correspond to adder 424 of FIG. 4. Register 806 may correspond to reciprocal 430 of FIG. 4. Register 810 may correspond to register 426 of FIG. 4. FP multiplier 814 may correspond to multiplier 428 of FIG. 4. The SoftMax accelerator, e.g., in FP adder 804, may incorporate the hardware logic illustrated in FIG. 7B to handle scaling and include a scale register 812 to store the scale factor for the accumulated value stored in register 806. The scale factor can be computed according to the algorithm depicted in FIG. 7A and by logic illustrated in FIG. 7B.

Scale register 812 stores the scale factor by which the accumulated value in register 806 was scaled back to prevent overflow. The scale factor can be populated by scaling handling logic implemented in or with FP adder 804. To prevent overflow in the reciprocal, the accumulated value in register 806 is passed to FP reciprocal 808, and the scale factor in scale register 812 is not passed through to FP reciprocal 808. Since the scaling was done by a power of two (such as the integer 128 for single-precision), the rescaling can be applied at FP multiplier 814 where FP multiplier 814 is effectively performing a division operation by multiplying an exponential with the reciprocal value in register 810. Specifically, the scale factor in scale register 812 (such as 128) is subtracted from the exponent part of the input exponential calculated by FP exponential 802. This rescaling can be handled in different ways, either by manipulating an exponent of an input exponential, or using a custom FP multiplier that allows for rescaling.

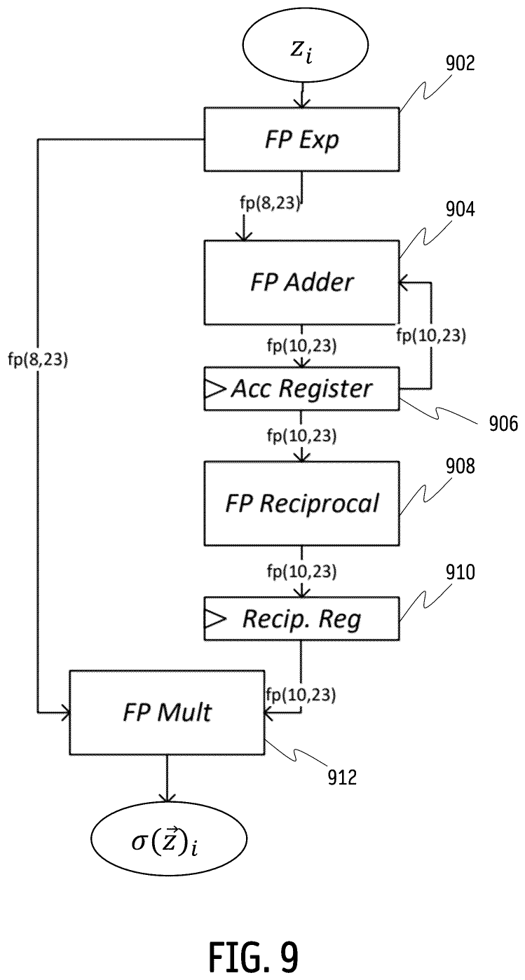

In addressing issue (A), it is possible to use a non-standard floating-point format to extend the dynamic range of the exponent part of a floating-point representation. FIG. 9 illustrates hardware components in a further exemplary SoftMax accelerator, according to some embodiments of the disclosure. The SoftMax accelerator may calculate

$${σ ( \vec{z} )}_{i} = \frac{{e}^{{z}_{i}}}{{\sum }_{j = 1}^{K} {e}^{{z}_{j}}}$$

based on zᵢ. The SoftMax accelerator may include FP exponential 902, FP adder 904, register 906, FP reciprocal 908, register 910, and FP multiplier 912. FP exponential 902 may correspond to exponential 422 of FIG. 4. FP adder 904 may correspond to adder 424 of FIG. 4. Register 906 may correspond to reciprocal 430 of FIG. 4. Register 910 may correspond to register 426 of FIG. 4. FP multiplier 912 may correspond to multiplier 428 of FIG. 4.

Herein, fp(B1, B2) denotes that the output has a floating-point representation where B1 number of bits are used to represent the exponent part and B2 number of bits are used to represent the mantissa part.

Understanding that the accumulated value in register 906 overflows when the running sum of exponentials to be calculated pushes the exponent outside the representable exponent range. For single-precision floating-point representation, the non-biased exponent range is [127, −126]. Since the algorithm accumulates (only) positive values (e.g., exponentials), overflow can occur if the exponentials being summed have exponent parts which are near the maximum exponent value allowed for the exponent range. In the case of single-precision, extending the bit width of exponent part by 1 bit increases the range of the exponent to [255, −254]. Extending the bit width of the exponent part by 2 bits increases the range of the exponent to [511, −510]. This extended exponent range can ensure that up to 2¹²⁶ exponentials that have near maximum value can be summed or accumulated without a risk of overflow. FP adder 904 can be extended to widen the bit width of the exponent part of the output. Register 906 can be extended to store more bits. FP reciprocal 908 can be extended to calculate a reciprocal based on an input with a wider exponent format. Register 910 can be extended to store more bits. FP multiplier 912 can be extended to perform multiplication based on an input with a wider exponent format and output a SoftMax output according to a standard floating-point format. The SoftMax accelerator as shown can include a component which operates with a floating-point format where an exponent part is represented by 9 bits or 10 bits (e.g., fp(9, 23), or fp(10, 23)). In some cases, the exponent part may be represented by more than 10 bits. Modifications to a standard arithmetic component to implement a component which operates on an input whose exponent part has a wider bit width may add some area, such as a few gates. The additional area or complexity is minimal.

In an alternative or complementary implementation, FP adder 904 may include a custom FP adder which has an increased dynamic range.

In addressing issue (B), it is possible to implement one or more custom arithmetic components. When computing the exponentials, e^{z}^{ᵢ}, the results can easily overflow. For single-precision, if inputs are larger than 89.5 then the result will overflow the format. Computing the exponential of a large 8-bit unsigned value (e.g., [0,255]) may yield exponentials that overflow and have exponents as high as 367. In a software implementation, the maximum input is first determined, then all exponentials are computed on scaled input values (zᵢ-scale). This prevents the overflow that may occur when calling the library function, exp(·), but would first inspect the inputs to determine the maximum value. An alternative solution that makes determining the maximum input value unnecessary is the use of a custom exponential component that can operate on a wider output exponent (e.g., 9-bit representation, 10-bit representation, or more than 10-bit representation). The wider output exponent can correspond to a practicable and representable) input range of [−510, 511] and prevents overflows for the [0,255] input range (or the [−128,127] range).

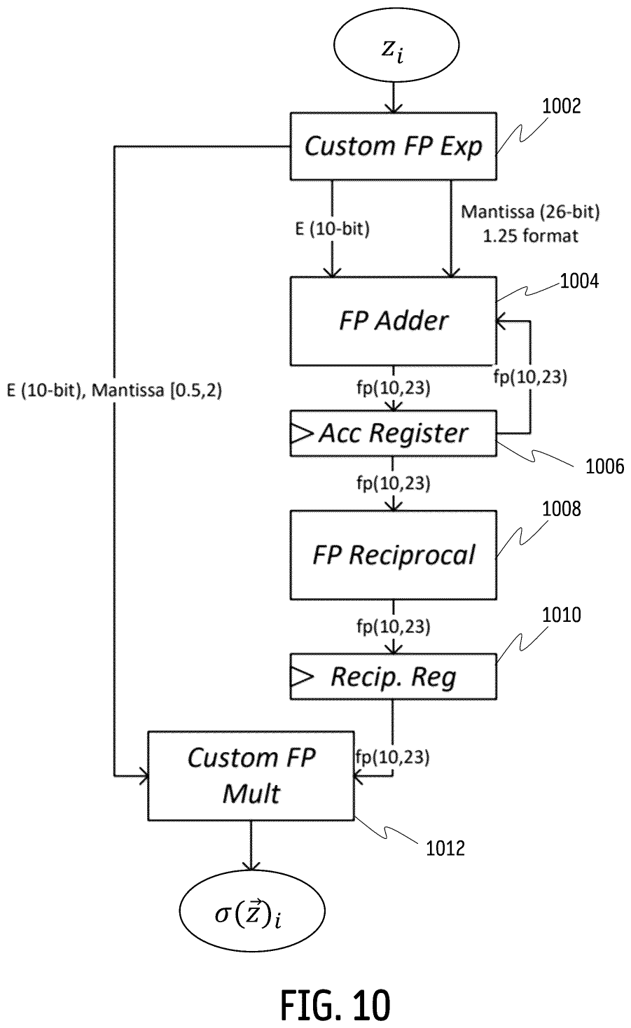

FIG. 10 illustrates hardware components in a yet further exemplary SoftMax accelerator, according to some embodiments of the disclosure. The SoftMax accelerator may calculate

$${σ ( \vec{z} )}_{i} = \frac{{e}^{{z}_{i}}}{{\sum }_{j = 1}^{K} {e}^{{z}_{j}}}$$

based on zᵢ. The SoftMax accelerator may include custom FP exponential 1002, FP adder 1004, register 1006, FP reciprocal 1008, register 1010, and custom FP multiplier 1012. Custom FP exponential 1002 may correspond to exponential 422 of FIG. 4. FP adder 1004 may correspond to adder 424 of FIG. 4. Register 1006 may correspond to reciprocal 430 of FIG. 4. Register 1010 may correspond to register 426 of FIG. 4. Custom FP multiplier 1012 may correspond to multiplier 428 of FIG. 4.

Extending the exponent output range for custom FP exponential 1002 does not add significant complexity in a custom implementation. When computing the exponential, range-reduction can decompose the input value x into an integer E multiple of log 2 and a small y(typically in between [−log 2/2, log 2/2]). This can be written as x=Elog(2)+y, where E is an integer. Note that based on this rewrite, the exponential computed by custom FP exponential 1002, exp(x), is equal to:

$$exp ( E log 2 + y ) = exp ( E log 2 ) * exp ( y ) = 2 \hat{} E * exp ( y ) \qquad ( eq . 5 )$$

The representation based on x=Elog(2)+y is close to the IEEE-754 representation of a floating-point value, with the only exception that exp(y) in the IEEE-754 representation is normalized (e.g., having values in [1,2)). The custom representation has exp(y) in a 1.25 format. Normalization is applied in IEEE-754 representation because y may have values in [−log 2/2, log 2/2], which means that exp(y) has values in [sqrt(2)/2, sqrt(2)], or approximately [0.707, 1,414]. The normalization stage kicks-in when the exp(y)<1. When exp(y)<1, exp(y) is multiplied by 2, so that exp(y) belongs to [1,2), and the exponent part is decremented by 1.

In the implementation illustrated in FIG. 10, the hardware logic to implement the exponential is simplified in custom FP exponential 1002. Custom FP exponential 1002 allows for a temporary (or intermediate) exponent E together with an unnormalized mantissa y (having values [0.5, 2)) as inputs to FP adder 1004. Custom FP exponential 1002 outputs an exponent value E and an unnormalized mantissa value y to represent the exponential (e.g., e^{z}^{ᵢ}=2∧E*exp(y)) being computed by custom FP exponential 1002. FP adder 1004 can receive the exponent value E, the unnormalized mantissa value y, and an accumulated value in register 1006 and perform accumulation of the exponentials. Custom FP multiplier may be implemented to receive a temporary exponent E together with an unnormalized mantissa y (having values [0.5, 2)) as input and perform multiplication with the reciprocal value stored in register 1010 accordingly. In some implementations, the exponent value E is represented by 9 bits or 10 bits (or more). In some implementations, the unnormalized mantissa value y having range [0.5, 2) is represented by 26 bits (or more). In some implementations, the accumulated value stored in register 1006 can have a floating-point format where an exponent part is represented by 9 bits or 10 bits (or more).

Effectively, special-case handling for preventing overflow in the exponential can be skipped and reduce hardware cost and complexity. Because the internal results are not written to a main memory, the floating-point format can be modified, and custom logic can be implemented to perform arithmetic operations and accommodate wider bit widths or different representations.

### Supporting Modified Implementations of SoftMax

Some modified implementations of SoftMax have been proposed, which can still be implemented as part of compute block 488 of in-line SoftMax accelerator 402 of FIG. 4. The aspect of tapping or intercepting output data produced by GEMM core 306 remains complementary with the modified implementations of SoftMax, because the modified implementations still involve two or more phases of operation. Modified implementations of SoftMax can still take advantage of reduced latency and utilize output data from GEMM core 306 received via in-line data path 404 while the GEMM core 306 is writing output data to memory during an initial phase of operation of the in-line SoftMax accelerator.

In one modified implementation of SoftMax, a natural base e may be replaced with a base of 2 to simplify arithmetic operations and allow for scaling. Furthermore, a maximum value is determined online without a separate pass on the input tensor. In a first pass (e.g., a denominator phase) over the input tensor, exponentials with the base of 2 are calculated and accumulated to calculate a running denominator value. In the first pass, a running maximum value observed so far is maintained. The calculated exponentials may be cached or stored in a memory. In a second pass (e.g., a numerator phase), the SoftMax output is calculated by dividing exponential (retrieved from a cache or memory) with the denominator value calculated in the first pass.

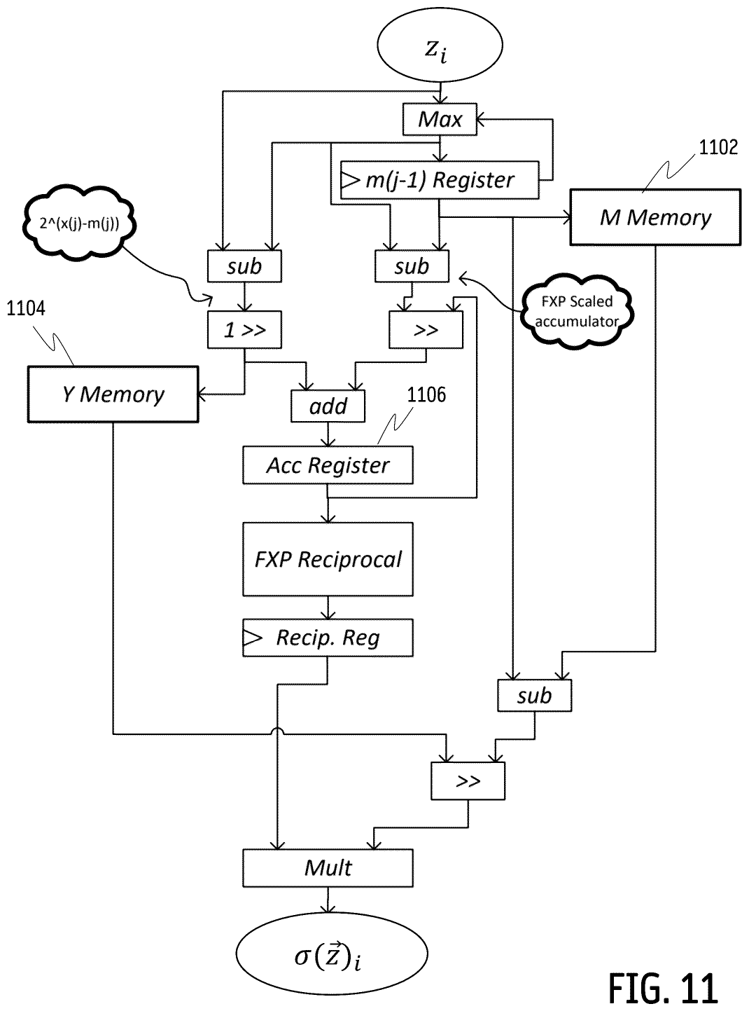

FIG. 11 illustrates hardware components in an exemplary SoftMax accelerator implemented modified SoftMax, according to some embodiments of the disclosure. For example, in one modified implementation of SoftMax, during a first pass, output values computed by a GEMM core can be received via an in-line data path as described with FIG. 4 and processed by the SoftMax accelerator depicted in FIG. 11. During the first pass, a maximum value of the input tensor observed so far (e.g., m(i) or max(zᵢ)) can be maintained in M memory 1102. In some implementations, Y memory 1104 may be included to store the calculated exponentials, e.g., 2∧(x(i)−m(i)), or 2^{z}^{ᵢ}^{-max(z}^{ᵢ}⁾. An accumulated value of the exponentials (e.g., a denominator value) may be stored in register 1106. During a second pass, the calculated exponentials cached/stored in Y memory 1104 may be used to calculate the SoftMax outputs. In some implementations, Y memory 1104 may be omitted by reading from memory the values of the input tensor zᵢ, and recalculating the numerator, 2∧(x(i)−m(i)), or 2^{z}^{ᵢ}^{-max(z}ᵢ⁾, based on the maximum value maintained in M memory 1102.

### An Exemplary Method for Performing SoftMax

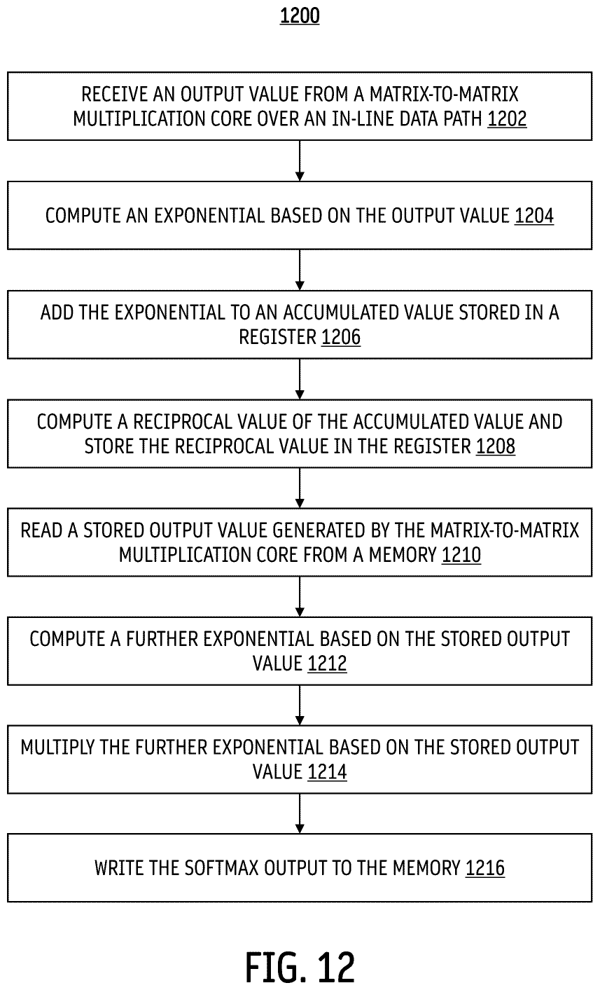

FIG. 12 is a flowchart showing method 1200 for performing at least a part of SoftMax in-line with a matrix-to-matrix multiplication core, according to some embodiments of the disclosure. Method 1200 may be performed by or carried out by components illustrated in FIG. 4.

In 1202, an output value is received from a matrix-to-matrix multiplication core over an in-line data path.

In 1204, an exponential is computed based on the output value.

In 1206, the exponential is added to an accumulated value stored in a register.

In 1208, a reciprocal value of the accumulated value is computed, and the reciprocal value is stored in the register (or a separate register).

In 1210, reading a stored output value generated by the matrix-to-matrix multiplication core from a memory.

In 1212, a further exponential is computed based on the stored output value.

In 1214, the further exponential is multiplied by the reciprocal value to produce a SoftMax output.

In 1216, the SoftMax output is written to the memory.

In some embodiments, method 1200 may further include receiving an instruction to perform at least a part of SoftMax in-line with the matrix-to-matrix multiplication core.

In some embodiments, method 1200 may further include receiving an instruction to perform SoftMax, the instruction comprising one or more of: an output base address for writing SoftMax outputs to a memory, an input base address from which output data generated by the matrix-to-matrix multiplication core is to be read from the memory, and a value specifying a number of output values from the in-line data path to process.

In some embodiments, method 1200 may further include, in response to receiving an instruction to perform SoftMax, enabling a processing path having an adder performing the adding.

In some embodiments, method 1200 may further include, after a number of exponentials are accumulated in the accumulated value, disabling a processing path having an adder performing the adding.

In some embodiments, method 1200 may further include storing a scale factor for the accumulated value in a further register.

In some embodiments, the exponential is represented by a floating-point format where an exponent part is represented by 8 bits. The accumulated value is represented by a further floating-point format where a further exponent part is represented by 9 bits or 10 bits.

In some embodiments, the exponential is represented by an exponent value and an unnormalized mantissa value. The accumulated value is represented by a floating-point format where an exponent part is represented by 9 bits or 10 bits. In some embodiments, the exponent value is represented by 9 bits or 10 bits. The accumulated value has a floating-point format where an exponent part is represented by 9 bits or 10 bits. In some embodiments, the unnormalized mantissa value is represented by 26 bits.

### An Exemplary Method for Invoking a SoftMax Accelerator

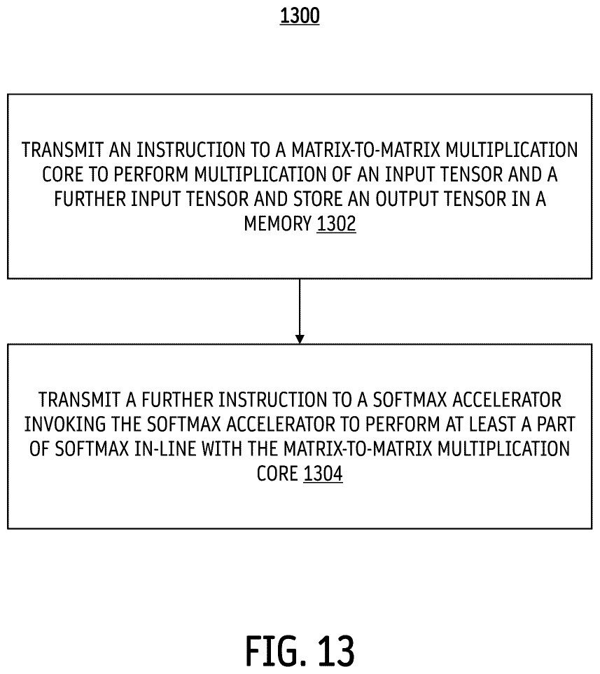

FIG. 13 is a flowchart showing method 1300 for causing a SoftMax accelerator to perform at least a part of SoftMax in-line with a matrix-to-matrix multiplication core, according to some embodiments of the disclosure. Method 1300 may be encoded in instructions stored on one or more non-transitory computer-readable media to cause a computing processor to perform the operations of method 1300.

In 1302, an instruction is transmitted to a matrix-to-matrix multiplication core to perform multiplication of an input tensor and a further input tensor and store an output tensor in a memory.

In 1304, a further instruction is transmitted to a SoftMax accelerator invoking the SoftMax accelerator to perform at least a part of SoftMax in-line with the matrix-to-matrix multiplication core.

In some embodiments, the further instruction comprises a value specifying a number of output values received from an in-line data path from the matrix-to-matrix multiplication core to be processed by the SoftMax accelerator.

In some embodiments, the further instruction comprises one or more of: an output base address for writing SoftMax outputs to the memory, an input base address from which output data generated by the matrix-to-matrix multiplication core is to be read from the memory.

In some embodiments, method 1300 may further include transmitting a yet further instruction to the SoftMax accelerator invoking the SoftMax accelerator to perform standalone SoftMax.

### Exemplary Computing Device

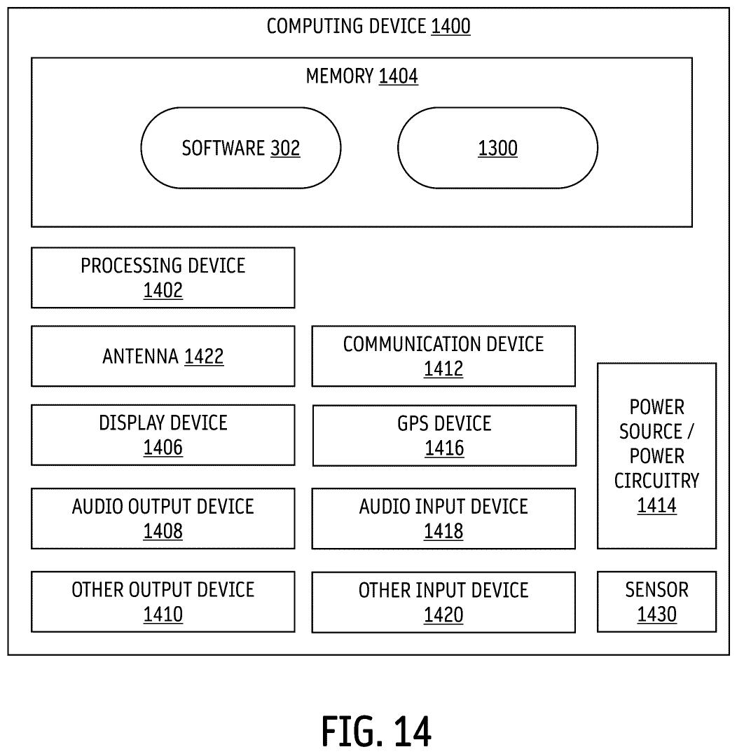

FIG. 14 is a block diagram of an apparatus or a system, e.g., an exemplary computing device 1400, according to some embodiments of the disclosure. One or more computing devices 1400 may be used to implement the functionalities described with the FIGS. and herein. A number of components illustrated in FIG. 14. can be included in the computing device 1400, but any one or more of these components may be omitted or duplicated, as suitable for the application. In some embodiments, some or all of the components included in the computing device 1400 may be attached to one or more motherboards. In some embodiments, some or all of these components are fabricated onto a single system on a chip (SoC) die. Additionally, in various embodiments, the computing device 1400 may not include one or more of the components illustrated in FIG. 14, and the computing device 1400 may include interface circuitry for coupling to the one or more components. For example, the computing device 1400 may not include a display device 1406, and may include display device interface circuitry (e.g., a connector and driver circuitry) to which a display device 1406 may be coupled. In another set of examples, the computing device 1400 may not include an audio input device 1418 or an audio output device 1408 and may include audio input or output device interface circuitry (e.g., connectors and supporting circuitry) to which an audio input device 1418 or audio output device 1408 may be coupled.

The computing device 1400 may include a processing device 1402 (e.g., one or more processing devices, one or more of the same types of processing device, one or more of different types of processing device). The processing device 1402 may include electronic circuitry that process electronic data from data storage elements (e.g., registers, memory, resistors, capacitors, quantum bit cells) to transform that electronic data into other electronic data that may be stored in registers and/or memory. Examples of processing device 1402 may include a CPU, a GPU, a quantum processor, a machine learning processor, an artificial intelligence processor, a neural network processor, an artificial intelligence accelerator, an ASIC, an analog signal processor, an analog computer, a microprocessor, a digital signal processor, an FPGA, TPU, a data processing unit (DPU), an NPU, etc. In some cases, processing device 1402 may include components such as GEMM core 306 and in-line SoftMax accelerator 402 illustrated in FIG. 4.

The computing device 1400 may include a memory 1404, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 1404 includes one or more non-transitory computer-readable storage media. In some embodiments, memory 1404 may include memory that shares a die with the processing device 1402.

In some embodiments, memory 1404 includes one or more non-transitory computer-readable media storing instructions executable to perform operations described with the FIGS. and herein, such as method 1300. In some embodiments, memory 1404 includes one or more non-transitory computer-readable media storing instructions executable to perform operations of software 302 of FIGS. 3-4. The instructions stored in the one or more non-transitory computer-readable media may be executed by processing device 1402.

In some embodiments, memory 1404 may store data, e.g., data structures, binary data, bits, metadata, files, blobs, etc., as described with the FIGS. and herein. Memory 1404 may store tensors and other data relating to operations of a DNN. In some cases, memory 1404 may include memory 304 illustrated in FIG. 4.

In some embodiments, memory 1404 may store one or more DNNs (and or parts thereof). Memory 1404 may store training data for training (trained) a DNN. Memory 1404 may store instructions that perform operations associated with training a DNN. Memory 1404 may store input data, output data, intermediate outputs, intermediate inputs of one or more DNNs. Memory 1404 may store one or more parameters used by the one or more DNNs. Memory 1404 may store information that encodes how nodes of the one or more DNNs are connected with each other. Memory 1404 may store instructions to invoke processing device 1402 to perform one or more operations of the one or more DNNs. Memory 1404 may store a model definition that specifies one or more operations of a DNN. Memory 1404 may store instructions that are generated by a compiler based on the model definition.

In some embodiments, the computing device 1400 may include a communication device 1412 (e.g., one or more communication devices). For example, the communication device 1412 may be configured for managing wired and/or wireless communications for the transfer of data to and from the computing device 1400. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 1412 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 1412 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 1412 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 1412 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 1412 may operate in accordance with other wireless protocols in other embodiments. The computing device 1400 may include an antenna 1422 to facilitate wireless communications and/or to receive other wireless communications (such as radio frequency transmissions). The computing device 1400 may include receiver circuits and/or transmitter circuits. In some embodiments, the communication device 1412 may manage wired communications, such as electrical, optical, or any other suitable communication protocols (e.g., the Ethernet). As noted above, the communication device 1412 may include multiple communication chips. For instance, a first communication device 1412 may be dedicated to shorter-range wireless communications such as Wi-Fi or Bluetooth, and a second communication device 1412 may be dedicated to longer-range wireless communications such as global positioning system (GPS), EDGE, GPRS, CDMA, WiMAX, LTE, EV-DO, or others. In some embodiments, a first communication device 1412 may be dedicated to wireless communications, and a second communication device 1412 may be dedicated to wired communications.

The computing device 1400 may include power source/power circuitry 1414. The power source/power circuitry 1414 may include one or more energy storage devices (e.g., batteries or capacitors) and/or circuitry for coupling components of the computing device 1400 to an energy source separate from the computing device 1400 (e.g., DC power, AC power, etc.).

The computing device 1400 may include a display device 1406 (or corresponding interface circuitry, as discussed above). The display device 1406 may include any visual indicators, such as a heads-up display, a computer monitor, a projector, a touchscreen display, a liquid crystal display (LCD), a light-emitting diode display, or a flat panel display, for example.

The computing device 1400 may include an audio output device 1408 (or corresponding interface circuitry, as discussed above). The audio output device 1408 may include any device that generates an audible indicator, such as speakers, headsets, or earbuds, for example.

The computing device 1400 may include an audio input device 1418 (or corresponding interface circuitry, as discussed above). The audio input device 1418 may include any device that generates a signal representative of a sound, such as microphones, microphone arrays, or digital instruments (e.g., instruments having a musical instrument digital interface (MIDI) output).

The computing device 1400 may include a GPS device 1416 (or corresponding interface circuitry, as discussed above). The GPS device 1416 may be in communication with a satellite-based system and may receive a location of the computing device 1400, as known in the art.

The computing device 1400 may include a sensor 1430 (or one or more sensors). The computing device 1400 may include corresponding interface circuitry, as discussed above). Sensor 1430 may sense physical phenomenon and translate the physical phenomenon into electrical signals that can be processed by, e.g., processing device 1402. Examples of sensor 1430 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 1400 may include another output device 1410 (or corresponding interface circuitry, as discussed above). Examples of the other output device 1410 may include an audio codec, a video codec, a printer, a wired or wireless transmitter for providing information to other devices, haptic output device, gas output device, vibrational output device, lighting output device, home automation controller, or an additional storage device.

The computing device 1400 may include another input device 1420 (or corresponding interface circuitry, as discussed above). Examples of the other input device 1420 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1400 may have any desired form factor, such as a handheld or mobile computer system (e.g., a cell phone, a smart phone, a mobile internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some embodiments, the computing device 1400 may be any other electronic device that processes data.

### Select Examples

Example 1 provides an apparatus, including a memory; a matrix-to-matrix multiplication core; and a SoftMax accelerator having: an in-line data path to receive output data from the matrix-to-matrix multiplication core; a compute block having one or more registers, one or more arithmetic components, and a finite state machine; and a memory controller to provide the output data received via the in-line data path to the compute block.
Example 2 provides the apparatus of example 1, where the memory controller is further to write one or more SoftMax outputs generated by the compute block to the memory.
Example 3 provides the apparatus of example 1 or 2, where the memory controller is further to receive an instruction to perform at least a part of SoftMax in-line with the matrix-to-matrix multiplication core.
Example 4 provides the apparatus of any one of examples 1-3, where the memory controller is further to receive an instruction to perform SoftMax, the instruction having a variable to indicate standalone execution or at least partial in-line execution.
Example 5 provides the apparatus of any one of examples 1-4, where the memory controller is further to receive an instruction to perform SoftMax, the instruction having one or more of: an output base address of the memory at which one or more SoftMax outputs generated by the compute block is to be written; an input base address of the memory from which the output data generated by the matrix-to-matrix multiplication core is to be read; and a value specifying an amount of the output data from the in-line data path that the SoftMax accelerator is to process.
Example 6 provides the apparatus of any one of examples 1-5, where the finite state machine has an idle phase, a denominator phase, and a numerator phase.
Example 7 provides the apparatus of any one of examples 1-6, where: the one or more arithmetic components includes an adder; and the finite state machine disables a processing path having the adder in response to determining the adder has performed a number of additions.
Example 8 provides the apparatus of any one of examples 1-7, where: the one or more registers include a register to store an accumulated value.
Example 9 provides the apparatus of any one of examples 1-8, where: the one or more registers include a register to store a reciprocal of an accumulated value.
Example 10 provides the apparatus of any one of examples 1-9, where: the one or more arithmetic components include one or more of: an exponential, an adder, a reciprocal, and a multiplier.
Example 11 provides the apparatus of any one of examples 1-10, where: the one or more registers include a register to store an accumulated value, and a further register to store a scale factor for the accumulated value.
Example 12 provides the apparatus of any one of examples 1-11, where: the one or more arithmetic components include a component which operates with a floating-point format where an exponent part is represented by 9 bits or 10 bits.
Example 13 provides the apparatus of any one of examples 1-12, where: the one or more arithmetic components include an exponential and an adder; the exponential outputs an exponent value and an unnormalized mantissa value; and the adder receives the exponent value, the unnormalized mantissa value, and an accumulated value.
Example 14 provides the apparatus of example 13, where: the exponent value is represented by 9 bits or 10 bits; and the accumulated value has a floating-point format where an exponent part is represented by 9 bits or 10 bits.
Example 15 provides the apparatus of example 13 or 14, where the unnormalized mantissa value is represented by 26 bits.
Example 16 provides the apparatus of any one of examples 1-15, where the matrix-to-matrix multiplication core performs convolution.
Example 17 provides the apparatus of any one of examples 1-16, where the matrix-to-matrix multiplication core performs matrix-to-matrix multiplication based on input tensors read from the memory and writes the output data to the memory.
Example 18 provides a method, including receiving an output value from a matrix-to-matrix multiplication core over an in-line data path; computing an exponential based on the output value; adding, the exponential to an accumulated value stored in a register; computing a reciprocal value of the accumulated value and storing the reciprocal value in the register; reading a stored output value generated by the matrix-to-matrix multiplication core from a memory; computing a further exponential based on the stored output value; multiplying the further exponential by the reciprocal value to produce a SoftMax output; and writing the SoftMax output to the memory.
Example 19 provides the method of example 18, further including receiving an instruction to perform at least a part of SoftMax in-line with the matrix-to-matrix multiplication core.
Example 20 provides the method of example 18 or 19, further including receiving an instruction to perform SoftMax, the instruction including one or more of: an output base address for writing SoftMax outputs to a memory; an input base address from which output data generated by the matrix-to-matrix multiplication core is to be read from the memory; and a value specifying a number of output values from the in-line data path to process.
Example 21 provides the method of any one of examples 18-20, further including in response to receiving an instruction to perform SoftMax, enabling a processing path having an adder performing the adding.
Example 22 provides the method of any one of examples 18-21, further including after a number of exponentials are accumulated in the accumulated value, disabling a processing path having an adder performing the adding.
Example 23 provides the method of any one of examples 18-22, further including storing a scale factor for the accumulated value in a further register.
Example 24 provides the method of any one of examples 18-23, where: the exponential is represented by a floating-point format where an exponent part is represented by 8 bits; and the accumulated value is represented by a further floating-point format where a further exponent part is represented by 9 bits or 10 bits.
Example 25 provides the method of any one of examples 18-24, where: the exponential is represented by an exponent value and an unnormalized mantissa value; and the accumulated value is represented by a floating-point format where an exponent part is represented by 9 bits or 10 bits.
Example 26 provides the method of example 25, where: the exponent value is represented by 9 bits or 10 bits; and the accumulated value has a floating-point format where an exponent part is represented by 9 bits or 10 bits.
Example 27 provides the method of example 25 or 26, where the unnormalized mantissa value is represented by 26 bits.
Example 28 provides one or more non-transitory computer-readable media storing instructions, that when executed on a processor, cause the processor to: transmit an instruction to a matrix-to-matrix multiplication core to perform multiplication of an input tensor and a further input tensor and store an output tensor in a memory; and transmit a further instruction to a SoftMax accelerator invoking the SoftMax accelerator to perform at least a part of SoftMax in-line with the matrix-to-matrix multiplication core.
Example 29 provides the one or more non-transitory computer-readable media of example 28, where the further instruction includes a value specifying a number of output values received from an in-line data path from the matrix-to-matrix multiplication core to be processed by the SoftMax accelerator.
Example 30 provides the one or more non-transitory computer-readable media of example 28 or 29, where the further instruction includes one or more of: an output base address for writing SoftMax outputs to the memory, an input base address from which output data generated by the matrix-to-matrix multiplication core is to be read from the memory.
Example 31 provides the one or more non-transitory computer-readable media of any one of examples 28-30, where the instructions further cause the processor to: transmit a yet further instruction to the SoftMax accelerator invoking the SoftMax accelerator to perform standalone SoftMax.
Example A provides a computer program product comprising instructions, that when executed by a processor, causes the processor to: transmit an instruction to a matrix-to-matrix multiplication core to perform multiplication of an input tensor and a further input tensor and store an output tensor in a memory; and transmit a further instruction to a SoftMax accelerator invoking the SoftMax accelerator to perform at least a part of SoftMax in-line with the matrix-to-matrix multiplication core.
Example B provides the computer program product of example A, where the further instruction includes a value specifying a number of output values received from an in-line data path from the matrix-to-matrix multiplication core to be processed by the SoftMax accelerator.
Example C provides the computer program product of example A or B, where the further instruction includes one or more of: an output base address for writing SoftMax outputs to the memory, an input base address from which output data generated by the matrix-to-matrix multiplication core is to be read from the memory.
Example D provides the computer program product of any one of examples A-C, where the instructions further cause the processor to: transmit a yet further instruction to the SoftMax accelerator invoking the SoftMax accelerator to perform standalone SoftMax.
Example E provides a computer program product comprising instructions, that when executed by a processor, causes the processor to perform a method illustrated by FIG. 12.
Example F provides a computer program product comprising instructions, that when executed by a processor, causes the processor to perform a method illustrated by FIG. 13.
Example G provides an apparatus comprising means for performing any one of the methods of examples 18-27.
Example H provides a DNN accelerator comprising one or more components illustrated in FIG. 4.
Example I provides an in-line SoftMax accelerator as illustrated in FIG. 4.
Example J provides an in-line SoftMax accelerator having logic illustrated in FIGS. 7B and 8.
Example K provides an in-line SoftMax accelerator having logic illustrated in FIG. 9.
Example L provides an in-line SoftMax accelerator having logic illustrated in FIG. 10.
Example M provides an in-line SoftMax accelerator having logic illustrated in FIG. 11.

### Variations and Other Notes

Although the operations of the example method shown in and described with reference to FIGS. are illustrated as occurring once each and in a particular order, it will be recognized that the operations may be performed in any suitable order and repeated as desired. Additionally, one or more operations may be performed in parallel. Furthermore, the operations illustrated in FIGS. may be combined or may include more or fewer details than described.

The various implementations described herein may refer to artificial intelligence, machine learning, and deep learning. Deep learning may be a subset of machine learning. Machine learning may be a subset of artificial intelligence. In cases where a deep learning model is mentioned, if suitable for a particular application, a machine learning model may be used instead. In cases where a deep learning model is mentioned, if suitable for a particular application, a digital signal processing system may be used instead.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. An apparatus, comprising:
a memory;
a matrix-to-matrix multiplication core; and
a SoftMax accelerator having:
an in-line data path to receive output data from the matrix-to-matrix multiplication core;
a compute block having one or more registers, one or more arithmetic components, and a finite state machine; and
a memory controller to provide the output data received via the in-line data path to the compute block.

2. The apparatus of claim 1, wherein the memory controller is further to write one or more SoftMax outputs generated by the compute block to the memory.

3. The apparatus of claim 1, wherein the memory controller is further to receive an instruction to perform at least a part of SoftMax in-line with the matrix-to-matrix multiplication core.

4. The apparatus of claim 1, wherein the memory controller is further to receive an instruction to perform SoftMax, the instruction having a variable to indicate standalone execution or at least partial in-line execution.

5. The apparatus of claim 1, wherein the memory controller is further to receive an instruction to perform SoftMax, the instruction having one or more of:
an output base address of the memory at which one or more SoftMax outputs generated by the compute block is to be written;
an input base address of the memory from which the output data generated by the matrix-to-matrix multiplication core is to be read; and
a value specifying an amount of the output data from the in-line data path that the SoftMax accelerator is to process.

6. The apparatus of claim 1, wherein the finite state machine has an idle phase, a denominator phase, and a numerator phase.

7. The apparatus of claim 1, wherein:
the one or more arithmetic components comprises an adder; and
the finite state machine disables a processing path having the adder in response to determining the adder has performed a number of additions.

8. The apparatus of claim 1, wherein:
the one or more registers comprise a register to store an accumulated value.

9. The apparatus of claim 1, wherein:
the one or more registers comprise a register to store a reciprocal of an accumulated value.

10. The apparatus of claim 1, wherein:
the one or more arithmetic components comprise one or more of: an exponential, an adder, a reciprocal, and a multiplier.

11. The apparatus of claim 1, wherein:
the one or more registers comprise a register to store an accumulated value, and a further register to store a scale factor for the accumulated value.

12. The apparatus of claim 1, wherein:
the one or more arithmetic components comprise a component which operates with a floating-point format where an exponent part is represented by 9 bits or 10 bits.

13. The apparatus of claim 1, wherein:
the one or more arithmetic components comprise an exponential and an adder;
the exponential outputs an exponent value and an unnormalized mantissa value; and
the adder receives the exponent value, the unnormalized mantissa value, and an accumulated value.

14. The apparatus of claim 13, wherein:
the exponent value is represented by 9 bits or 10 bits; and
the accumulated value has a floating-point format where an exponent part is represented by 9 bits or 10 bits.

15. The apparatus of claim 13, wherein the unnormalized mantissa value is represented by 26 bits.

16. A method, comprising:
receiving an output value from a matrix-to-matrix multiplication core over an in-line data path;
computing an exponential based on the output value;
adding, the exponential to an accumulated value stored in a register;
computing a reciprocal value of the accumulated value and storing the reciprocal value in the register;
reading a stored output value generated by the matrix-to-matrix multiplication core from a memory;
computing a further exponential based on the stored output value;
multiplying the further exponential by the reciprocal value to produce a SoftMax output; and
writing the SoftMax output to the memory.

17. The method of claim 16, further comprising:
receiving an instruction to perform at least a part of SoftMax in-line with the matrix-to-matrix multiplication core.

18. The method of claim 16, further comprising:
receiving an instruction to perform SoftMax, the instruction comprising one or more of:
an output base address for writing SoftMax outputs to a memory;
an input base address from which output data generated by the matrix-to-matrix multiplication core is to be read from the memory; and
a value specifying a number of output values from the in-line data path to process.

19. One or more non-transitory computer-readable media storing instructions, that when executed on a processor, cause the processor to:
transmit an instruction to a matrix-to-matrix multiplication core to perform multiplication of an input tensor and a further input tensor and store an output tensor in a memory; and
transmit a further instruction to a SoftMax accelerator invoking the SoftMax accelerator to perform at least a part of SoftMax in-line with the matrix-to-matrix multiplication core.

20. The one or more non-transitory computer-readable media of claim 19, wherein the further instruction comprises a value specifying a number of output values received from an in-line data path from the matrix-to-matrix multiplication core to be processed by the SoftMax accelerator.
